(19) United States
(12) Patent Application Publication
(10) Pub. No.: US 2022/0066451 A1
(43) Pub. Date: Mar. 3, 2022

(54) MOBILE ROBOT

(71) Applicant: PANASONIC INTELLECTUAL PROPERTY MANAGEMENT CO., LTD., Osaka (JP)

(72) Inventor: Fabio DALLA LIBERA, Osaka (JP)

(21) Appl. No.: 17/403,488

(22) Filed: Aug. 16, 2021

(30) Foreign Application Priority Data
Aug. 25, 2020 (JP) 2020-141504
Sep. 15, 2020 (JP) 2020-154374

(51) Int. Cl. G05D 1/02; H04N 5/225; G06T 7/246; G06T 7/73; A47L 9/28

(52) U.S. Cl. CPC G05D 1/027; H04N 5/2258; G06T 7/246; G06T 7/74; A47L 2201/04; A47L 9/2852; A47L 9/2805; G06T 2207/30252; G05D 2201/0215; G05D 1/0253

(57) ABSTRACT

A mobile robot that autonomously travels in a predetermined space includes a housing, a first camera attached to the housing and configured to generate a first lower image by photographing below the housing, a detector attached to the housing and configured to detect an attitude of the housing; a calculator configured to calculate a velocity of the mobile robot based on the attitude and the first lower image, an estimator configured to estimate a self-position of the mobile robot in the predetermined space based on the velocity; and a controller configured to control the mobile robot to travel based on the self-position.

### BACKGROUND

### 1. Technical Field

The present disclosure relates to a mobile robot that autonomously travels in a predetermined space.

### 2. Description of the Related Art

WO 2013/185102 (hereinafter, referred to as “PTL 1”) discloses a mobile robot that moves autonomously.

The mobile robot disclosed in PTL 1 estimates a traveling state of the mobile robot on a carpet based on information detected from a sensor or the like for detecting rotation of a wheel.

This type of mobile robot travels while estimating a position of the mobile robot itself in a traveling space. Hereinafter, the position of the mobile robot itself is referred to as a self-position. Therefore, the self-position in the space estimated by the mobile robot is required to have high accuracy.

### SUMMARY

The present disclosure provides a mobile robot capable of improving estimation accuracy of a self-position.

A mobile robot according to one aspect of the present disclosure is a mobile robot that autonomously travels in a predetermined space. The mobile robot includes a housing, a first camera that is attached to the housing and generates a first lower image by photographing below the housing, a detector that is attached to the housing and detects an attitude of the housing, a calculator that calculates a velocity of the mobile robot based on the attitude of the housing and the first lower image, an estimator that estimates the self-position of the mobile robot in the predetermined space based on the velocity calculated by the calculator, and a controller that causes the mobile robot to travel based on the self-position estimated by the estimator.

According to the aspect of the present disclosure, it is possible to provide the mobile robot capable of improving estimation accuracy of the self-position.

### BRIEF DESCRIPTION OF THE DRAWINGS

FIG. 1 is a side view illustrating an example of an external appearance of a mobile robot according to a first exemplary embodiment;

FIG. 2 is a front view illustrating an example of the external appearance of the mobile robot according to the first exemplary embodiment;

FIG. 3 is a block diagram illustrating a configuration example of the mobile robot according to the first exemplary embodiment;

FIG. 4 is a schematic view illustrating an example of an arrangement layout of each component of a sensor unit included in the mobile robot according to the first exemplary embodiment;

FIG. 5 is a flowchart illustrating an outline of a process procedure in the mobile robot according to the first exemplary embodiment;

FIG. 6 is a flowchart illustrating a process procedure in the mobile robot according to the first exemplary embodiment;

FIG. 7 is a block diagram illustrating a configuration example of a mobile robot according to a second exemplary embodiment;

FIG. 8 is a schematic view illustrating an example of an arrangement layout of each component of a sensor unit included in the mobile robot according to the second exemplary embodiment;

FIG. 9 is a flowchart illustrating a process procedure in the mobile robot according to the second exemplary embodiment;

FIG. 10 is a block diagram illustrating a configuration example of a mobile robot according to a third exemplary embodiment;

FIG. 11 is a schematic view illustrating an example of an arrangement layout of each component of a sensor unit included in the mobile robot according to the third exemplary embodiment;

FIG. 12A is a diagram for describing structured light;

FIG. 12B is a diagram for describing the structured light;

FIG. 13A is a diagram for describing the structured light;

FIG. 13B is a diagram for describing the structured light;

FIG. 14 is a flowchart illustrating a process procedure in the mobile robot according to the third exemplary embodiment;

FIG. 15 is a block diagram illustrating a configuration example of a mobile robot according to a fourth exemplary embodiment;

FIG. 16 is a diagram schematically illustrating an example of an arrangement layout of each component of a sensor unit included in the mobile robot according to the fourth exemplary embodiment;

FIG. 17 is a flowchart illustrating a process procedure in the mobile robot according to the fourth exemplary embodiment;

FIG. 18 is a block diagram illustrating a configuration example of a mobile robot according to a fifth exemplary embodiment;

FIG. 19 is a schematic view illustrating an example of an arrangement layout of each component of a sensor unit included in the mobile robot according to the fifth exemplary embodiment;

FIG. 20 is a schematic view illustrating a photographing direction of a camera included in the mobile robot according to the fifth exemplary embodiment;

FIG. 21 is a flowchart illustrating a process procedure in the mobile robot according to the fifth exemplary embodiment;

FIG. 22 is a block diagram illustrating a configuration example of a mobile robot according to a sixth exemplary embodiment;

FIG. 23 is a schematic view illustrating an example of an arrangement layout of each component of a sensor unit included in the mobile robot according to the sixth exemplary embodiment;

FIG. 24 is a flowchart illustrating a process procedure in the mobile robot according to the sixth exemplary embodiment;

FIG. 25 is a block diagram illustrating a configuration example of a mobile robot according to a seventh exemplary embodiment;

FIG. 26 is a schematic view illustrating an example of an arrangement layout of each component of a sensor unit included in the mobile robot according to the seventh exemplary embodiment;

FIG. 27 is a flowchart illustrating a process procedure in the mobile robot according to the seventh exemplary embodiment;

FIG. 28A is a diagram for describing a first example of a detection range of the mobile robot;

FIG. 28B is a diagram for describing a second example of the detection range of the mobile robot;

FIG. 28C is a diagram for describing a third example of the detection range of the mobile robot;

FIG. 28D is a diagram for describing a fourth example of the detection range of the mobile robot; and

FIG. 28E is a diagram for describing a traveling state of the mobile robot.

### DETAILED DESCRIPTION

### (Knowledge Underlying the Present Disclosure)

A mobile robot executes a task such as cleaning, sweeping, or data collection while moving, for example, along a calculated travel route. In the mobile robot that autonomously moves while executing such a task, it is required to move throughout a predetermined region. Therefore, the mobile robot is required to be able to accurately estimate the self-position. The mobile robot can detect information indicating positions of a wall, an object, and the like located around the mobile robot, using a sensor such as light detection and ranging (LIDAR), and can estimate its self-position using the detected information. The mobile robot estimates the self-position by comparing a map with the information detected by LIDAR using, for example, a localized algorithm.

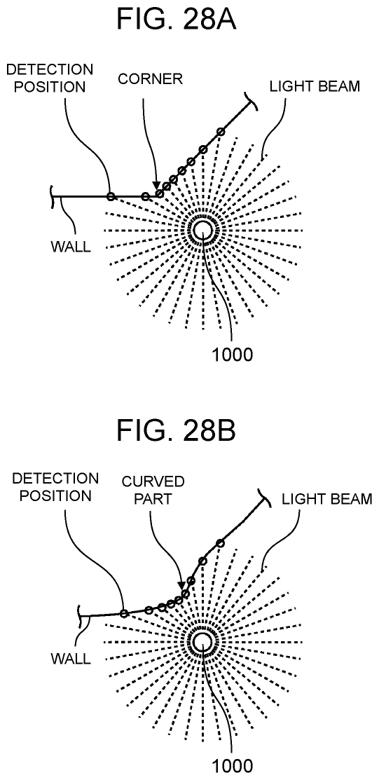

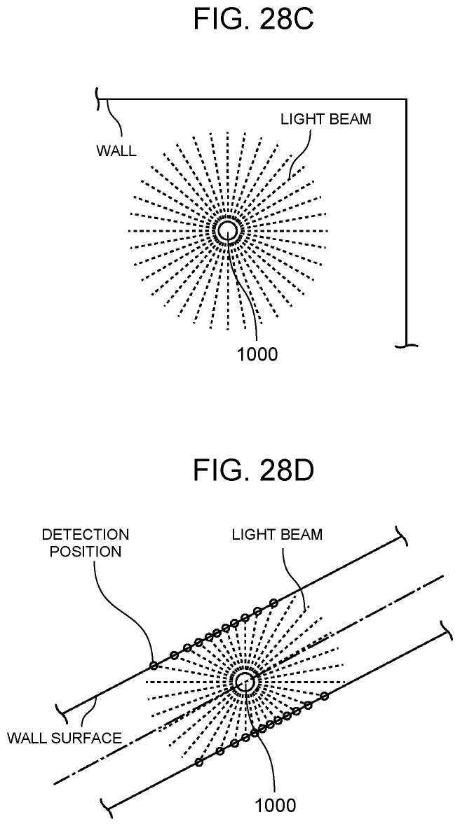

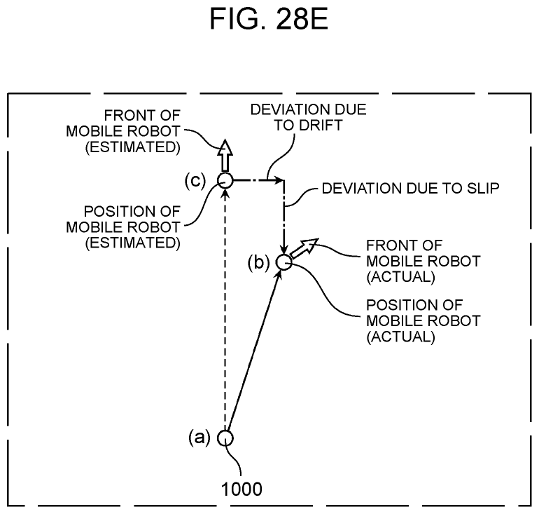

FIG. 28A is a diagram for describing a first example of a detection range of mobile robot 1000. Specifically, FIG. 28A is a schematic top view for describing the first example of a detection range when mobile robot 1000 detects a surrounding object using LIDAR.

Mobile robot 1000 measures, for example, a distance to an object such as a wall using LIDAR. When the object is within a range detectable by LIDAR, mobile robot 1000 detects by LIDAR a characteristic position such as a corner included in the wall. For example, mobile robot 1000 detects one or more detection positions from reflected light of a light beam output from LIDAR, and then detects a characteristic position such as a corner, i.e., a feature point, among one or more detection positions that have been detected. In FIG. 28A, the light beam output from LIDAR is indicated by broken lines, and the detection positions are indicated by circles. As a result, mobile robot 1000 calculates the self-position based on the position of the detected corner. In this way, mobile robot 1000 estimates the self-position.

FIG. 28B is a diagram for describing a second example of the detection range of mobile robot 1000. Specifically, FIG. 28B is a schematic top view for describing the second example of the detection range when mobile robot 1000 detects a surrounding object using LIDAR.

Similarly to the first example, mobile robot 1000 detects one or more detection positions from the reflected light of the light beam output from LIDAR, and then detects a characteristic position (feature point) such as a curved part among one or more detection positions that have been detected. As a result, mobile robot 1000 estimates the self-position based on the position of the detected curved part.

As described above, when detecting the feature point using LIDAR, mobile robot 1000 estimates the self-position with reference to the feature point.

However, as illustrated in the following example, mobile robot 1000 may not be able to estimate the self-position with information obtained from LIDAR.

FIG. 28C is a diagram for describing a third example of the detection range of mobile robot 1000. Specifically, FIG. 28C is a schematic top view for describing the third example of the detection range when mobile robot 1000 detects a surrounding object using LIDAR.

In the third example, a wall is located around mobile robot 1000 outside the range where an object can be detected by LIDAR. Thus, mobile robot 1000 cannot detect the position of the wall. Therefore, in the third example, mobile robot 1000 cannot estimate the self-position using LIDAR.

FIG. 28D is a diagram for describing a fourth example of the detection range of mobile robot 1000. Specifically, FIG. 28D is a schematic top view for describing the fourth example of the detection range when mobile robot 1000 detects a surrounding object using LIDAR.

In the fourth example, a wall is located around mobile robot 1000 within a range where an object can be detected by LIDAR. However, the wall does not include a feature point such as a corner or a curved part. Therefore, in the fourth example, mobile robot 1000 can estimate the self-position assuming that the self-position is located at one point on a one-dot chain line illustrated in FIG. 28D, but cannot estimate at which point on the one-dot chain line the self-position is located. Therefore, in the fourth example, mobile robot 1000 cannot accurately estimate the self-position.

As described above, for example, in a case where a wall, an object, or the like having a corner for identifying the self-position does not exist, such as a straight passage, in the surrounding environment of mobile robot 1000, the information obtained from the sensor such as LIDAR does not change at the place where mobile robot 1000 is located. Therefore, mobile robot 1000 cannot accurately estimate the self-position.

Furthermore, for example, in a case where mobile robot 1000 includes a camera that photographs an upper side, mobile robot 1000 can estimate the self-position based on the position of an object located on the upper side photographed by the camera. However, even in such a case, mobile robot 1000 may not be able to accurately estimate the self-position due to reasons such as the surrounding is too dark to photograph clearly by the camera when mobile robot 1000 enters under furniture or the like that is not exposed to light.

Therefore, mobile robot 1000 estimates the self-position using not only the information obtained from LIDAR, the camera, or the like, but also odometry information obtained from a wheel provided in mobile robot 1000 in order to move mobile robot 1000.

The odometry information indicates in which direction and how much each wheel of mobile robot 1000 has been rotated. In the case of a legged robot, the odometry information indicates how each leg has moved.

As a result, mobile robot 1000 can estimate the self-position based on the odometry information that is information on the moving operation performed by mobile robot 1000, without using the information on the object located around mobile robot 1000.

However, the self-position estimated based on the odometry information may have a large error with respect to an actual position of mobile robot 1000 as illustrated in the following example.

FIG. 28E is a diagram for describing a traveling state of mobile robot 1000. Specifically, FIG. 28E is a schematic top view for describing a deviation between the self-position estimated by mobile robot 1000 and the actual position. Note that, in the example illustrated in FIG. 28E, it is assumed that mobile robot 1000 can accurately estimate the self-position illustrated in part (a) of FIG. 28E.

After a while from continuous traveling, mobile robot 1000 can estimate the self-position based on the odometry information on the rotation of the wheel.

Here, for example, it is assumed that a deviation due to slip and a deviation due to drift such as sideslip has occurred in mobile robot 1000 during traveling, and a heading drift has occurred. The deviation due to the slip means that a difference occurs between the number of rotations of the wheel of mobile robot 1000 and an actual traveling distance of mobile robot 1000. The deviation due to the drift means that a difference occurs between a direction of the wheel of mobile robot 1000 and an actual traveling direction of mobile robot 1000. The heading drift means that an unintended change occurs in the traveling direction of mobile robot 1000. In this case, such a deviation is not detected from the odometry information indicating the number of rotations of the wheel or the like. Therefore, for example, even when mobile robot 1000 is actually located at the position indicated by part (b) of FIG. 28E and advances in the direction indicated by an arrow in part (b) of FIG. 28E, mobile robot 1000 estimates that mobile robot 1000 is located at a position indicated by part (c) of FIG. 28E and advances in the direction indicated by an arrow in Part (c) of FIG. 28E when the self-position is estimated from the odometry information. Thus, the self-position estimated only from the odometry information may deviate from the actual position.

Therefore, when mobile robot 1000 continues to estimate the self-position using the odometry information, the deviation between the actual position and the estimated position continues to increase.

In a case where new information is obtained from LIDAR, mobile robot 1000 can estimate the self-position based on the new information to reduce the deviation. However, in a case where new information cannot be obtained from LIDAR for a long time, the estimation accuracy of the self-position of mobile robot 1000 continues to decrease.

As a result of intensive studies, the inventors of the present disclosure have found that the estimation accuracy of the self-position can be improved by calculating a velocity of the mobile robot based on a lower image of the mobile robot photographed by the mobile robot and an attitude of the mobile robot, and estimating the self-position based on the calculated velocity.

Hereinafter, exemplary embodiments of the mobile robot according to the present disclosure will be described in detail with reference to the drawings. Numerical values, shapes, materials, components, arranged positions and connection forms of the components, steps, order of steps, etc., to be used in the following exemplary embodiments are illustrative and are not to limit the scope of the present disclosure.

Note that the attached drawings and the following description are provided for those skilled in the art to fully understand the present disclosure, and are not intended to limit the subject matter as described in the appended claims.

Each of the drawings is a schematic diagram, and is not necessarily strictly illustrated. In the drawings, substantially the same components are denoted by the same reference marks, and redundant description may be omitted or simplified.

In the following exemplary embodiments, a case where the mobile robot traveling in the predetermined space is viewed from vertically above may be described as a top view, and a case where the mobile robot is viewed from vertically below may be described as a bottom view. In addition, a direction in which the mobile robot travels may be referred to as forward, and a direction opposite to the direction in which the mobile robot travels may be referred to as backward.

In the description and the drawings, an X axis, a Y axis, and a Z axis indicate three axes of a three-dimensional orthogonal coordinate system. In each exemplary embodiment, the Z-axis direction is a vertical direction, and a direction perpendicular to the Z-axis (a direction parallel to an XY plane) is a horizontal direction.

A positive direction of the Z axis is defined as vertically upward, and a positive direction of the X axis is defined as a direction in which the mobile robot travels, i.e., forward.

In addition, a case where the mobile robot is viewed from the front side of the mobile robot is also referred to as a front view. In addition, a case where the mobile robot is viewed from a direction orthogonal to the direction in which the mobile robot travels and the vertical direction is also referred to as a side view.

Still more, a surface on which the mobile robot travels may be simply referred to as a floor surface.

Furthermore, in the description, a velocity with respect to the direction in which the mobile robot advances is referred to as a translational velocity or simply a velocity, a velocity with respect to rotation is referred to as an angular velocity (rotational velocity). A velocity obtained by combining the translational velocity and the angular velocity is also referred to as a combined velocity or simply a velocity.

### First Exemplary Embodiment

### [Configuration]

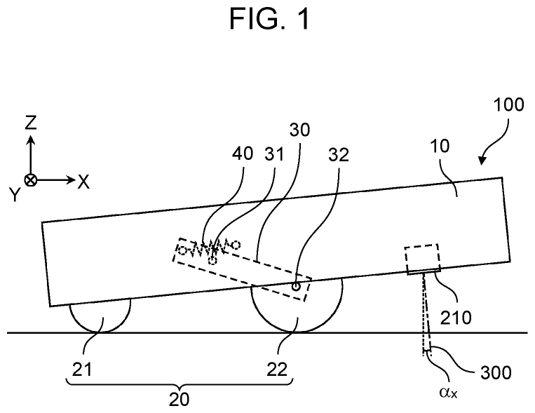

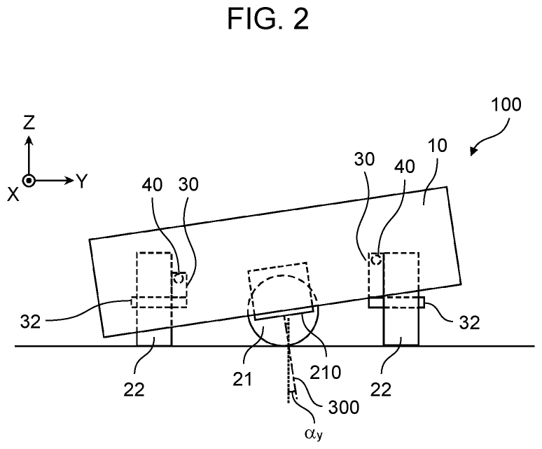

FIG. 1 is a side view illustrating an example of an external appearance of mobile robot 100 according to a first exemplary embodiment. FIG. 2 is a front view illustrating an example of the external appearance of mobile robot 100 according to the first exemplary embodiment. In FIG. 1 and FIG. 2, some of the components included in mobile robot 100 are omitted.

Mobile robot 100 is, for example, an apparatus that executes a task such as cleaning, sweeping, or data collection while autonomously moving using a simultaneous localization and mapping (SLAM) technology.

Mobile robot 100 includes housing 10, first camera 210, wheel 20, suspension arm 30, and spring 40.

Housing 10 is an outer housing of mobile robot 100. Each component included in mobile robot 100 is attached to housing 10.

First camera 210 is a camera that is attached to housing 10 and photographs below housing 10. Specifically, first camera 210 is attached to housing 10 with its optical axis facing downward. More specifically, first camera 210 is attached to a lower side of housing 10 such that a direction in which first camera 210 photographs is directed to a floor surface on which mobile robot 100 travels.

Note that an attachment position of first camera 210 is not particularly limited as long as first camera 210 is attached to housing 10 at a position where a lower side of mobile robot 100 can be photographed. First camera 210 may be attached to any position such as a side surface, a bottom surface, or inside of housing 10.

A photographing direction of first camera 210 may be not only the vertically lower side of mobile robot 100 but also an obliquely lower side inclined with respect to the vertical direction.

Wheel 20 is a wheel for moving mobile robot 100, that is, for causing mobile robot 100 to travel. Caster wheel 21 and two traction wheels 22 are attached to housing 10.

Each of two traction wheels 22 is attached to housing 10 via wheel hub 32 and suspension arm 30, and is movable with respect to housing 10 with suspension pivot 31 as a rotation axis. Suspension arm 30 is attached to housing 10 by spring 40.

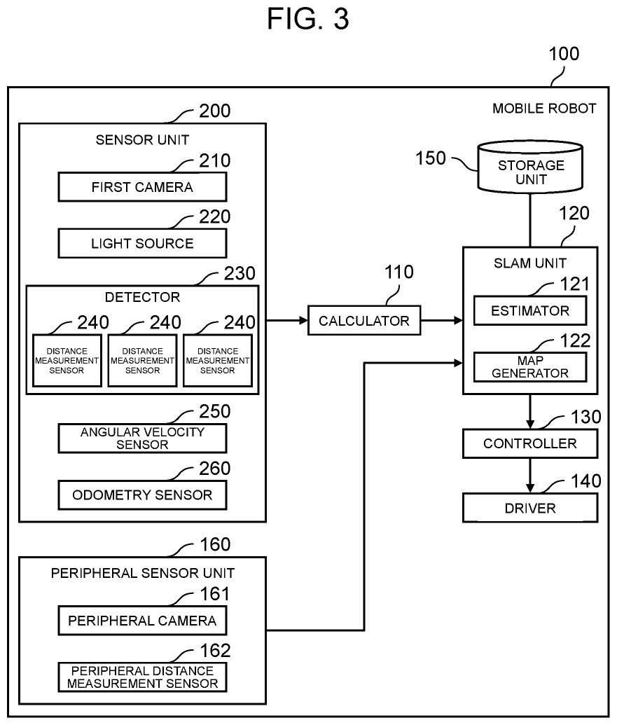

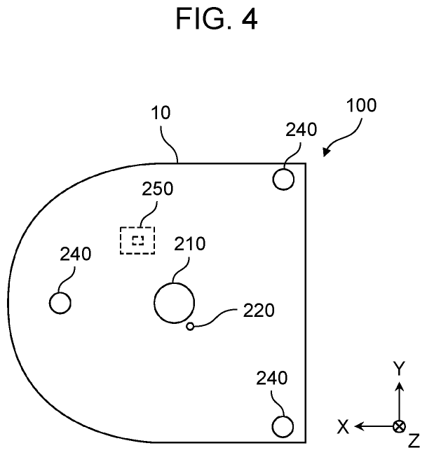

FIG. 3 is a block diagram illustrating a configuration example of mobile robot 100 according to the first exemplary embodiment. FIG. 4 is a schematic view illustrating an example of an arrangement layout of each component of sensor unit 200 included in mobile robot 100 according to the first exemplary embodiment. Note that FIG. 4 illustrates the arrangement layout of a part of sensor unit 200 as viewed from the bottom surface side of housing 10, and illustration of other components of sensor unit 200, wheel 20, and the like is omitted.

Mobile robot 100 includes sensor unit 200, peripheral sensor unit 160, calculator 110, SLAM unit 120, controller 130, driver 140, and storage unit 150.

Sensor unit 200 is a sensor group that detects information for calculating the velocity of mobile robot 100. In the present exemplary embodiment, sensor unit 200 includes first camera 210, light source 220, detector 230, angular velocity sensor 250, and odometry sensor 260.

First camera 210 is a camera that is attached to housing 10 and generates an image by photographing below housing 10. Hereinafter, the image photographed by first camera 210 is also referred to as a first lower image. First camera 210 periodically and repeatedly outputs the first lower image generated to calculator 110. First camera 210 only needs to be able to detect a light distribution based on light source 220 described later. In first camera 210, a wavelength of light to be detected, the number of pixels, and the like are not particularly limited.

Light source 220 is a light source that is attached to housing 10 and emits light toward below housing 10. For example, first camera 210 generates the first lower image by detecting reflected light of light emitted from light source 220 and reflected on the floor surface on which mobile robot 100 travels. Light source 220 is, for example, a light emitting diode (LED), a laser diode (LD), or the like. A wavelength of the light output from light source 220 is not particularly limited as long as the wavelength can be detected by first camera 210.

Detector 230 is a device that is attached to housing 10 and detects an attitude of housing 10. Specifically, detector 230 detects inclination of housing 10 with respect to a predetermined reference direction and a distance between housing 10 and the floor surface. Note that the inclination of housing 10 is represented by α and γ described later, and the distance between housing 10 and the floor surface is represented by h described later.

In the present exemplary embodiment, detector 230 includes three distance measurement sensors 240.

Each of three distance measurement sensors 240 is a sensor that measures the distance between the floor surface on which mobile robot 100 travels and housing 10. Distance measurement sensor 240 is, for example, an active infrared sensor.

As illustrated in FIG. 4, when housing 10 is viewed from the bottom, first camera 210 is attached to, for example, a central part of housing 10, and light source 220 is attached in the vicinity of first camera 210. The vicinity is a range in which first camera 210 can appropriately detect the light from light source 220 reflected on the floor surface. In addition, three distance measurement sensors 240 are attached to, for example, a peripheral part of housing 10 at a distance from each other when housing 10 is viewed from the bottom.

Each of three distance measurement sensors 240 periodically and repeatedly outputs information (height information) on a measured distance (height) to calculator 110. The measured distance here represents the height. Hereinafter, the information on the measured height is also referred to as height information.

Note that detector 230 only needs to include three or more distance measurement sensors 240. The number of distance measurement sensors 240 included in detector 230 may be four, or may be five or more.

The configuration is further described with reference to FIG. 3 again. Angular velocity sensor 250 is a sensor that is attached to housing 10 and measures an angular velocity, i.e., rotational velocity, of mobile robot 100. Angular velocity sensor 250 is, for example, an inertial measurement unit (IMU) including a gyro sensor. Angular velocity sensor 250 periodically and repeatedly outputs the angular velocity measured (angular velocity information) to calculator 110.

Odometry sensor 260 is a sensor that measures the number of rotations of wheel 20, i.e., odometry information. Odometry sensor 260 periodically and repeatedly outputs the odometry information measured to calculator 110.

First camera 210, detector 230, and odometry sensor 260 operate in synchronization with each other by a processor such as calculator 110, and periodically and repeatedly output each piece of information at the same time to calculator 110.

Peripheral sensor unit 160 is a sensor group that detects information on a predetermined space where mobile robot 100 travels. Specifically, peripheral sensor unit 160 is a sensor group that detects information required for mobile robot 100 to estimate the self-position and travel by detecting a position, a feature point, or the like of an obstacle, a wall, or the like in the predetermined space.

Peripheral sensor unit 160 includes peripheral camera 161 and peripheral distance measurement sensor 162.

Peripheral camera 161 is a camera that photographs the periphery such as the side of and above mobile robot 100. Peripheral camera 161 generates an image of the predetermined space by photographing an object such as an obstacle or a wall located in the predetermined space where mobile robot 100 travels. Peripheral camera 161 outputs the generated image (image information) to SLAM unit 120.

Peripheral distance measurement sensor 162 is LIDAR that measures a distance to an object such as an obstacle or a wall located around, such as the side of, mobile robot 100. Peripheral distance measurement sensor 162 outputs the measured distance (distance information) to SLAM unit 120.

Calculator 110 is a processor that calculates a velocity (translational velocity) of mobile robot 100 based on the attitude of housing 10 and the first lower image. For example, calculator 110 calculates the attitude of housing 10 based on the distance obtained from each of the three or more distance measurement sensors 240. For example, calculator 110 repeatedly acquires the first lower image from first camera 210 and compares changes in acquired images to calculate a moving velocity of the image, i.e., the velocity (translational velocity) of mobile robot 100.

In addition, calculator 110 calculates, from the calculated translational velocity and the angular velocity acquired from angular velocity sensor 250, a velocity in consideration of a direction in which mobile robot 100 has traveled, i.e., a combined velocity. Calculator 110 outputs the calculated combined velocity to SLAM unit 120. Note that calculator 110 may output the calculated translational velocity and the angular velocity acquired from angular velocity sensor 250 to SLAM unit 120 without combining the respective pieces of information.

SLAM unit 120 is a processor that generates a map (map information) of the predetermined space where mobile robot 100 travels using the SLAM technique described above, and calculates (estimates) the self-position of mobile robot 100 in the predetermined space. More specifically, the self-position of mobile robot 100 in the predetermined space is coordinates on a map of the predetermined space. SLAM unit 120 includes estimator 121 and map generator 122.

Estimator 121 estimates the self-position of mobile robot 100 in the predetermined space. Specifically, estimator 121 calculates the self-position of mobile robot 100 in the predetermined space based on the velocity (translational velocity) calculated by calculator 110. In the present exemplary embodiment, estimator 121 calculates the self-position of mobile robot 100 based on the angular velocity measured by angular velocity sensor 250 and the translational velocity calculated by the calculator. In the following exemplary embodiments including the present exemplary embodiment, calculation of the self-position of mobile robot 100 by estimator 121 is also referred to as estimation of the self-position of mobile robot 100 by estimator 121. In other words, the estimation by estimator 121 is a calculation result in estimator 121.

For example, estimator 121 estimates the self-position of mobile robot 100 based on information acquired from peripheral sensor unit 160. Alternatively, when the self-position of mobile robot 100 cannot be estimated based on the information acquired from peripheral sensor unit 160, estimator 121 estimates the self-position of mobile robot 100 based on the translational velocity and the angular velocity of mobile robot 100, i.e., the combined velocity, acquired from calculator 110. For example, after estimating the self-position of mobile robot 100 based on the initial position or the information acquired from peripheral sensor unit 160, estimator 121 can estimate the current self-position of mobile robot 100 from the self-position and the combined velocity even when mobile robot 100 travels thereafter.

Map generator 122 generates a map of the predetermined space where mobile robot 100 travels, using the SLAM technique described above. For example, when the map of the predetermined space is not stored in storage unit 150, controller 130 controls driver 140 to cause mobile robot 100 travel while map generator 122 acquires information from sensor unit 200 and peripheral sensor unit 160 to generate the map of the predetermined space. The generated map of the predetermined space is stored in storage unit 150.

Note that the map of the predetermined space may be stored in storage unit 150. In this case, SLAM unit 120 may not include map generator 122.

Controller 130 is a processor that controls driver 140 to cause mobile robot 100 to travel. Specifically, controller 130 controls mobile robot 100 to travel based on the self-position estimated by estimator 121. For example, controller 130 calculates a travel route based on the map generated by map generator 122. Controller 130 controls driver 140 to cause mobile robot 100 to travel along the travel route calculated based on the self-position estimated by the estimator 121.

Note that the travel route (travel route information) may be stored in advance in storage unit 150.

The processor such as calculator 110, SLAM unit 120, and controller 130 are realized by, for example, a control program for executing the above-described processes and a central processing unit (CPU) that executes the control program. Various processors may be realized by one CPU or may be realized by a plurality of CPUs. Note that components of each of processors may be configured by dedicated hardware using one or a plurality of dedicated electronic circuits or the like instead of software.

Driver 140 is a device for causing mobile robot 100 to travel. Driver 140 includes, for example, a drive motor for rotating wheel 20 and caster wheel 21. For example, controller 130 controls the drive motor to rotate caster wheel 21 to cause mobile robot 100 to travel.

Storage unit 150 is a storage device that stores the map of the predetermined space and control programs executed by various processors such as calculator 110, SLAM unit 120, and controller 130. Storage unit 150 is realized by, for example, a hard disk drive (HDD), a flash memory, or the like. [Velocity calculation process]

Next, a specific calculation method of the combined velocity of mobile robot 100 will be described. Specifically, a procedure for calculating vₓ and v_{y}, which are components of the velocity (translational velocity) of mobile robot 100, and ω, which is a component of the angular velocity, using α, γ, and h that indicate the attitude of mobile robot 100 will be described. Here, α and γ both represent angles indicating the direction of housing 10, and h represents the distance (i.e., height) between housing 10 and the floor surface.

In mobile robot 100, since caster wheel 21 is movable with respect to housing 10, the attitude, for example, of housing 10 with respect to a traveling floor surface changes as appropriate. Therefore, mobile robot 100 can easily climb over a small object and can appropriately travel even on an uneven floor surface.

Here, since caster wheel 21 is movable with respect to housing 10, housing 10 is not necessarily positioned parallel to the floor surface. For example, inclination of a bottom surface of housing 10 with respect to the floor surface changes continuously during traveling of mobile robot 100. Thus, the attitude of the bottom surface of housing 10 with respect to the floor surface, more specifically, a distance between the bottom surface of housing 10 and the floor surface changes continuously during traveling of mobile robot 100.

Therefore, for example, when the front-back direction of housing 10 (for example, the bottom surface of housing 10) is inclined with respect to the floor surface while mobile robot 100 is traveling, the optical axis of first camera 210 disposed in housing 10 at the initial position in which the optical axis (photographing direction) is set parallel to a normal line of the floor surface is inclined with respect to the normal line.

For example, in a side view as illustrated in FIG. 1, the optical axis of first camera 210 is inclined at angle αₓ with respect to the normal line of the floor surface when the bottom surface of housing 10 is inclined in the front-back direction with respect to the floor surface.

Further, for example, as illustrated in FIG. 2, mobile robot 100 is inclined in the left-right direction due to a difference in tension between springs 40 on the left and right sides connected to caster wheel 21 via suspension arm 30. The left-right direction is a direction perpendicular to the traveling direction of mobile robot 100 in a top view of mobile robot 100.

For example, in a front view as illustrated in FIG. 2, the optical axis of first camera 210 is inclined at angle α_{y} with respect to the normal line of the floor surface when the bottom surface of housing 10 is inclined in the left-right direction with respect to the floor surface.

Here, it is assumed that mobile robot 100 is traveling on a flat floor surface. A reference frame of mobile robot 100 with respect to the floor surface is at distance (height) h from the floor surface, and a quaternion corresponding to an axis (rotation axis) parallel to a direction of an axis of rot [cos (γ), sin (γ), 0]^{T} and rotation at angle α [rad] around the axis is expressed by the following Equation (1).

$$\begin{matrix}[ Mathematical expression 1 ] & \\ {q}_{r}^{w} = cos ( \frac{α}{2} ) + sin ( \frac{α}{2} ) cos ( γ ) i + sin ( \frac{α}{2} ) sin ( γ ) j + 0 k & Formula ( 1 )\end{matrix}$$

Here, γ is an angle [rad] indicating how housing 10 is inclined with respect to the floor surface. More specifically, γ is an angle [rad] indicating how housing 10 is inclined with respect to a reference attitude of housing 10. For example, γ=0 indicates that housing 10 is inclined to the left or right. In other words, γ=0 indicates the inclination of housing 10 when housing 10 is viewed from the front. In addition, γ=π/2 indicates that housing 10 is inclined to the front or back. In other words, γ=π/2 indicates the inclination of housing 10 when housing 10 is viewed from the side.

In the above Equation (1), each of i, j, and k is a unit of quaternion.

The reference frame refers to coordinates arbitrarily determined with reference to mobile robot 100. For example, in the reference frame, a gravity center position of mobile robot 100 is defined as the origin, the front-back direction of mobile robot 100 is defined as the X direction, the left-right direction of mobile robot 100 is defined as the Y direction, and the up-down direction of mobile robot 100 is defined as the Z direction. In the present description, w indicates the world coordinate system, and c indicates a coordinate system based on a camera provided in the mobile robot of the present disclosure.

Here, it is assumed that attitude (−α, γ+π) in the case of α≥0 and attitude (α, γ) in the case of α<0 are equivalent.

It is also assumed that i pieces of first cameras 210 are mounted on housing 10 at positions [rᵢ cos (Ψᵢ), rᵢ (Ψᵢ), bᵢ]^{T} in the reference frame of mobile robot 100. In this case, the quaternion of the i-th first camera 210 is expressed by the following Equation (2).

[Mathematical Expression 2]

qᵢ^{r}=q_{i,z}^{r}q_{i,xy}^{r} Formula (2)

In other words, the quaternion of the i-th first camera 210 is represented by a product of the quaternion in the Z coordinate of the i-th first camera 210 and a photographing position of the i-th first camera 210 on the floor surface. In addition, z in Equation (2) means rotation of mobile robot 100 around the Z axis. In addition, xy means rotation around an axis arbitrarily set to be parallel to the XY plane.

Design parameters Ψᵢ, rᵢ, and bᵢ are predetermined by the positional relationship among the components of mobile robot 100. Parameter Ψ is angle [rad] formed with a predetermined reference axis as viewed from a predetermined reference origin. The reference origin is, for example, a virtual point corresponding to the gravity center position of mobile robot 100. The reference axis is, for example, a virtual axis that passes through the reference origin and is parallel to the front of mobile robot 100. Parameter r is a distance between the reference origin and first camera 210 (for example, the center of a light receiving sensor in first camera 210). Parameter b is a distance in the height direction from a reference surface including the reference axis. The reference surface is, for example, a virtual surface that passes through the reference origin and is parallel to the bottom surface of housing 10 when mobile robot 100 is not operated.

In addition, the following Mathematical Expression 3 satisfies the following Equations (3) and (4), respectively.

$$\begin{matrix}[ Mathematical expression 3 ] & \\ {q}_{i , z}^{r} , {q}_{i , xy}^{r} & \\ [ Mathematical expression 4 ] & \\ {q}_{i , z}^{r} = cos ( \frac{{ψ}_{i}}{2} ) + 0 i + 0 j + sin ( \frac{{ψ}_{i}}{2} ) k & Formula ( 3 ) \\ {q}_{i , x y}^{r} = cos ( \frac{β}{2} ) + sin ( \frac{β}{2} ) cos ( θ ) i + sin ( \frac{β}{2} ) sin ( θ ) j + 0 k & Formula ( 4 )\end{matrix}$$

Note that β and θ are design parameters predetermined by the positional relationship between the components of mobile robot 100. Parameter β is a predetermined rotation angle [rad] around an axis, with respect to the reference axis, passing through first camera 210 (for example, the center of the light receiving sensor in first camera 210) and the reference axis is orthogonal in the reference surface. In addition, parameter θ is a rotation angle [rad] around an axis orthogonal to the reference surface and passing through first camera 210 (for example, the center of the light receiving sensor in first camera 210).

In this manner, the position of the i-th first camera 210 in the world coordinate system is determined as shown in the following Equation (5). The world coordinate system is a coordinate system that is arbitrarily determined in advance.

$$\begin{matrix}[ Mathematical expression 5 ] & \\ {t}_{i}^{w} = [ \begin{matrix}{b}_{i} sin ( α ) sin ( γ ) - 2 {r}_{i} {sin}^{2} ( \frac{α}{2} ) sin ( γ ) sin ( γ - {ψ}_{i} ) + {r}_{i} cos ( {ψ}_{i} ) \\ - {b}_{i} sin ( α ) cos ( γ ) + 2 {r}_{i} {sin}^{2} ( \frac{α}{2} ) sin ( γ ) cos ( γ - {ψ}_{i} ) - 2 {r}_{i} {sin}^{2} ( \frac{α}{2} ) sin ( {ψ}_{i} ) + {r}_{i} sin ( {ψ}_{i} ) \\ {b}_{i} cos ( α ) + h - {r}_{i} sin ( α ) sin ( γ - {ψ}_{i} )\end{matrix} ] & Formula ( 5 )\end{matrix}$$

Furthermore, the quaternion representing the rotation of the i-th first camera 210 (rotation in a predetermined arbitrary direction) is expressed by the following Equation (6).

$$\begin{matrix} [ Mathematical expression 6 ] & \\ {q}_{i}^{w} = \{ - sin ( \frac{α}{2} ) sin ( \frac{{β}_{i}}{2} ) cos ( - γ + \frac{{ψ}_{i}}{2} + {θ}_{i} ) + cos ( \frac{α}{2} ) cos ( \frac{{β}_{i}}{2} ) cos ( \frac{{ψ}_{i}}{2} ) \} + \{ sin ( \frac{α}{2} ) cos ( \frac{{β}_{i}}{2} ) cos ( γ - \frac{{ψ}_{i}}{2} ) + sin ( \frac{{β}_{i}}{2} ) cos ( \frac{α}{2} ) cos ( \frac{{ψ}_{i}}{2} + {θ}_{i} ) \} i + \{ sin ( \frac{α}{2} ) sin ( γ - \frac{{ψ}_{i}}{2} ) cos ( \frac{{β}_{i}}{2} ) + sin ( \frac{{β}_{i}}{2} ) sin ( \frac{{ψ}_{i}}{2} + {θ}_{i} ) cos ( \frac{α}{2} ) \} j + \{ sin ( \frac{α}{2} ) sin ( \frac{{β}_{i}}{2} ) sin ( - y + \frac{{ψ}_{i}}{2} + {θ}_{i} ) + sin ( \frac{{ψ}_{i}}{2} ) cos ( \frac{α}{2} ) cos ( \frac{{β}_{i}}{2} ) \} k & Formula ( 6 )\end{matrix}$$

Furthermore, in this case, the i-th first camera 210 photographs pᵢ, which is a position on the floor surface, shown in the following Equation (7).

$$\begin{matrix}[ Mathematical expression 7 ] & \\ {p}_{i} = [ \begin{matrix}{p}_{i , x} \\ {p}_{i , y} \\ 0\end{matrix} ] & Formula ( 7 )\end{matrix}$$

Here, p_{i,x} and p_{i,y} satisfy the following Equations (8) and (9).

$$\begin{matrix} [ Mathematical expression 8 ] & \\ {p}_{i , x} = {b}_{i} sin ( α ) sin ( γ ) - 2 {r}_{i} {sin}^{2} ( \frac{α}{2} ) sin ( γ ) sin ( γ - {ψ}_{i} ) + {r}_{i} cos ( {ψ}_{i} ) + κ \{ - 2 {sin}^{2} ( \frac{α}{2} ) sin ( {β}_{i} ) sin ( γ ) cos ( - γ + {ψ}_{i} + {θ}_{i} ) + sin ( α ) sin ( γ ) cos ( {β}_{i} ) + sin ( {β}_{i} ) sin ( {ψ}_{i} + {θ}_{i} ) \} & Formula ( 8 ) \\ {p}_{i , y} = - {b}_{i} sin ( α ) cos ( γ ) + 2 {r}_{i} {sin}^{2} ( \frac{α}{2} ) sin ( γ ) cos ( γ - {ψ}_{i} ) - 2 {r}_{i} {sin}^{2} ( \frac{α}{2} ) sin ( {ψ}_{i} ) + {r}_{i} sin ( {ψ}_{i} ) + κ \{ 2 {sin}^{2} ( \frac{α}{2} ) sin ( {β}_{i} ) sin ( γ ) sin ( - γ + {ψ}_{i} + {θ}_{i} ) + 2 {sin}^{2} ( \frac{a}{2} ) sin ( {β}_{i} ) cos ( {ψ}_{i} + {θ}_{i} ) - sin ( α ) cos ( {β}_{i} ) cos ( y ) - sin ( {β}_{i} ) cos ( {ψ}_{i} + {θ}_{i} ) \} & Formula ( 9 )\end{matrix}$$

Furthermore, κ satisfies the following Equation (10).

$$\begin{matrix} [ Mathematical expression 9 ] & \\ K = \frac{{b}_{i} cos ( α ) + h - {r}_{i} sin ( α ) sin ( γ - {ψ}_{i} )}{sin ( α ) sin ( {β}_{i} ) cos ( - γ + {ψ}_{i} + {θ}_{i} ) - cos ( α ) cos ( {β}_{i} )} & Formula ( 10 )\end{matrix}$$

When mobile robot 100 moves on the floor surface at a translational velocity expressed by the following Mathematical Expression 10 and an angular velocity expressed by the following Mathematical Expression 11, an apparent velocity at pᵢ is expressed by the following Equation (11).

$$\begin{matrix}[ Mathematical expression 10 ] & \\ \vec{v} = [ \begin{matrix}{v}_{x} \\ {v}_{y} \\ 0\end{matrix} ] & \\ [ Mathematical expression 11 ] & \\ \vec{ω} = [ \begin{matrix}0 \\ 0 \\ ω\end{matrix} ] & \\ [ Mathematical expression 12 ] & \\ \vec{{v}_{i}^{w}} = [ \begin{matrix}{V}_{i , x}^{w} \\ {v}_{i , y}^{w} \\ {v}_{i , z}^{w}\end{matrix} ] = - [ \begin{matrix}- ω {p}_{i , y} + {v}_{x} \\ ω {p}_{i , x} + {v}_{y} \\ 0\end{matrix} ] & Formula ( 11 )\end{matrix}$$

The velocity of the i-th first camera 210 calculated from a photographing result of the i-th first camera 210, i.e., the combined velocity of mobile robot 100, satisfies the following Equation (12).

$$\begin{matrix}[ Mathematical expression 13 ] & \\ \vec{{v}_{i}^{c}} = {J}_{i} [ \begin{matrix}{v}_{i , x}^{w} \\ {v}_{i , y}^{w}\end{matrix} ] & Formula ( 12 )\end{matrix}$$

Note that matrix Jᵢ in a case where first camera 210 is a telecentric camera is expressed by the following Equation (13).

$$\begin{matrix}[ Mathematical expression 14 ] & \\ {J}_{i , t} = [ \begin{matrix}{m}_{w 11}^{c} & {m}_{w 12}^{c} \\ {m}_{w 21}^{c} & {m}_{w 22}^{c}\end{matrix} ] & Formula ( 13 )\end{matrix}$$

Here, m is a rotational translation matrix for converting a value from the world coordinate system to the reference frame.

Note that the telecentric camera is a camera that includes a light receiving sensor, a light source, and a telecentric lens that is a lens for removing parallax. In the telecentric camera, the light source emits light via the telecentric lens, and the light receiving sensor detects (or photographs) reflected light from an object such as a floor.

Alternatively, matrix Jᵢ in a case where first camera 210 is a pinhole camera is expressed by the following Equation (14).

$$\begin{matrix}[ Mathematical expression 15 ] & \\ {J}_{i , p} = [ \begin{matrix}{J}_{p 11} & {J}_{p 12} \\ {J}_{p 21} & {J}_{p 22}\end{matrix} ] & Formula ( 14 )\end{matrix}$$

Note that the pinhole camera is a camera using a hole (pinhole) without using a lens.

In the pinhole camera and a camera employing a so-called normal lens that is not the telecentric lens, the size of a photographed object in an image decreases as a distance between the object and the camera increases. In the present exemplary embodiment, first camera 210 may be the telecentric camera or may not be the telecentric camera.

Here, Jₚ₁₁, Jₚ₁₂, Jₚ₁₃, and Jₚ₁₄ satisfy the following Equations (15), (16), (17), and (18).

$$\begin{matrix} [ Mathematical expression 16 ] & \\ {J}_{p 11} = \frac{\begin{matrix}f \{ - {m}_{w 11}^{c} ( {m}_{w 31}^{c} {p}_{i , x} + {m}_{w 32}^{c} {p}_{i , y} + {m}_{w 34}^{c} ) + \\ {m}_{w 31}^{c} ( {m}_{w 11}^{c} {p}_{i , x} + {m}_{w 12}^{c} {p}_{i , y} + {m}_{w 14}^{c} ) \}\end{matrix}}{{( {m}_{w 31}^{c} {p}_{i , x} + {m}_{ w 32}^{c} {p}_{i , y} + {m}_{w 33}^{c} )}^{2}} & Formula ( 15 ) \\ {J}_{p 12} = \frac{\begin{matrix}f \{ - {m}_{w 12}^{c} ( {m}_{w 31}^{c} {p}_{i , x} + {m}_{w 32}^{c} {p}_{i , y} + {m}_{w 24}^{c} ) + \\ {m}_{w 32}^{c} ( {m}_{w 11}^{c} {p}_{i , x} + {m}_{w 12}^{c} {p}_{i , y} + {m}_{w 14}^{c} ) \}\end{matrix}}{{( {m}_{w 31}^{c} {p}_{i , x} + {m}_{ w 32}^{c} {p}_{i , y} + {m}_{w 34}^{c} )}^{2}} & Formula ( 16 ) \\ {J}_{p 21} = \frac{\begin{matrix}f \{ - {m}_{w 21}^{c} ( {m}_{w 31}^{c} {p}_{i , x} + {m}_{w 32}^{c} {p}_{i , y} + {m}_{w 24}^{c} ) + \\ {m}_{w 21}^{c} ( {m}_{w 21}^{c} {p}_{i , x} + {m}_{w 22}^{c} {p}_{i , y} + {m}_{w 24}^{c} ) \}\end{matrix}}{{( {m}_{w 31}^{c} {p}_{i , x} + {m}_{ w 32}^{c} {p}_{i , y} + {m}_{w 34}^{c} )}^{2}} & Formula ( 17 ) \\ {J}_{p 22} = \frac{\begin{matrix}f \{ - {m}_{w 22}^{c} ( {m}_{w 31}^{c} {p}_{i , x} + {m}_{w 32}^{c} {p}_{i , y} + {m}_{w 24}^{c} ) + \\ {m}_{w 32}^{c} ( {m}_{w 21}^{c} {p}_{i , x} + {m}_{w 22}^{c} {p}_{i , y} + {m}_{w 24}^{c} ) \}\end{matrix}}{{( {m}_{w 31}^{c} {p}_{i , x} + {m}_{ w 32}^{c} {p}_{i , y} + {m}_{w 34}^{c} )}^{2}} & Formula ( 18 )\end{matrix}$$

Note that f is a focal length of first camera 210.

In addition, each m is expressed by the following Equations (19) to (28).

$$\begin{matrix} [ Mathematical expression 17 ] & \\ {m}_{w 11}^{c} = 4 {sin}^{2} ( \frac{α}{2} ) {sin}^{2} ( \frac{{β}_{i}}{2} ) sin ( γ ) sin ( {θ}_{i} ) cos ( - γ + {ψ}_{i} + {θ}_{i} ) - 2 {sin}^{2} ( \frac{α}{2} ) sin ( γ ) sin ( γ - {ψ}_{i} ) - sin ( α ) sin ( {β}_{i} ) sin ( γ ) sin ( {θ}_{i} ) - 2 {sin}^{2} ( \frac{{β}_{i}}{2} ) sin ( {θ}_{i} ) sin ( {ψ}_{i} + {θ}_{i} ) + cos ( {ψ}_{i} ) & Formula ( 19 ) \\ {m}_{w 12}^{c} = - \{ 2 {sin}^{2} ( \frac{{β}_{i}}{2} ) {sin}^{2} ( {θ}_{i} ) - 1 \} \{ 2 {sin}^{2} ( \frac{α}{2} ) sin ( γ ) cos ( γ - {ψ}_{i} ) - 2 {sin}^{2} ( \frac{α}{2} ) sin ( {ψ}_{i} ) + sin ( {ψ}_{i} ) \} + 2 \{ 2 {sin}^{2} ( \frac{α}{2} ) sin ( γ ) sin ( γ - {ψ}_{i} ) - 2 {sin}^{2} ( \frac{α}{2} ) cos ( {ψ}_{i} ) + cos ( {ψ}_{i} ) \} {sin}^{2} ( \frac{{β}_{i}}{2} ) sin ( {θ}_{i} ) cos ( {θ}_{i} ) + sin ( α ) sin ( {β}_{i} ) sin ( {θ}_{i} ) cos ( γ ) & Formula ( 20 ) \\ {m}_{w 13}^{c} = 2 sin ( α ) {sin}^{2} ( \frac{{β}_{i}}{2} ) sin ( {θ}_{i} ) cos ( - γ + {ψ}_{i} + {θ}_{i} ) - sin ( α ) sin ( γ - {ψ}_{i} ) - sin ( {β}_{i} ) sin ( {θ}_{i} ) cos ( α ) & Formula ( 21 ) \\ [ Mathematical expression 18 ] & \\ {m}_{w 21}^{c} = - \{ 2 {sin}^{2} ( \frac{{β}_{i}}{2} ) {cos}^{2} ( {θ}_{i} ) - 1 \} \{ 2 {sin}^{2} ( \frac{α}{2} ) sin ( γ ) cos ( γ - {ψ}_{i} ) - sin ( {θ}_{i} ) \} - 2 \{ 2 {sin}^{2} ( \frac{α}{2} ) sin ( γ ) sin ( γ - {ψ}_{i} ) - cos ( {ψ}_{i} ) \} {sin}^{2} ( \frac{{β}_{i}}{2} ) sin ( {θ}_{i} ) cos ( {θ}_{i} ) + sin ( α ) sin ( {β}_{i} ) sin ( γ ) cos ( {θ}_{i} ) & Formula ( 22 ) \\ {m}_{w 22}^{c} = - \{ 2 {sin}^{2} ( \frac{{β}_{i}}{2} ) {cos}^{2} ( {θ}_{i} ) - 1 \} \{ 2 {sin}^{2} ( \frac{α}{2} ) sin ( γ ) sin ( γ - {ψ}_{i} ) - 2 {sin}^{2} ( \frac{α}{2} ) cos ( {ψ}_{i} ) cos ( {ψ}_{i} ) \} + 2 \{ 2 {sin}^{2} ( \frac{α}{2} ) sin ( γ ) cos ( γ - {ψ}_{i} ) - 2 {sin}^{2} ( \frac{α}{2} ) sin ( {ψ}_{i} ) + sin ( {ψ}_{i} ) \} {sin}^{2} ( \frac{{β}_{i}}{2} ) sin ( {θ}_{i} ) cos ( {θ}_{i} ) - sin ( α ) sin ( {β}_{i} ) cos ( γ ) cos ( {θ}_{i} ) & Formula ( 23 ) \\ {m}_{w 23}^{c} = - \{ 2 {sin}^{2} ( \frac{{β}_{i}}{2} ) {cos}^{2} ( {θ}_{i} ) - 1 \} sin ( α ) cos ( γ - {ψ}_{i} ) - 2 sin ( α ) {sin}^{2} ( \frac{{β}_{i}}{2} ) sin ( {θ}_{i} ) sin ( γ - {θ}_{i} ) cos ( {θ}_{i} ) + sin ( {β}_{i} ) cos ( α ) cos ( {β}_{i} ) & Formula ( 24 ) \\ [ Mathematical expression 19 ] & \\ {m}_{w 31}^{c} = - 2 {sin}^{2} ( \frac{α}{2} ) sin ( {β}_{i} ) sin ( γ ) cos ( - γ + {ψ}_{i} + {θ}_{i} ) + sin ( α ) sin ( γ ) cos ( {β}_{i} ) + sin ( {β}_{i} ) sin ( {ψ}_{i} + {θ}_{i} ) & Formula ( 25 ) \\ {m}_{w 32}^{c} = 2 {sin}^{2} ( \frac{α}{2} ) sin ( {β}_{i} ) sin ( γ ) sin ( - γ + {ψ}_{i} + {θ}_{i} ) + 2 {sin}^{2} ( \frac{α}{2} ) sin ( {β}_{i} ) cos ( {ψ}_{i} + {θ}_{i} ) - sin ( α ) cos ( {β}_{i} ) cos ( γ ) - sin ( {β}_{i} ) cos ( {ψ}_{i} + {θ}_{i} ) & Formula ( 26 ) \\ {m}_{w 33}^{c} = - sin ( α ) sin ( {β}_{i} ) cos ( - γ + {ψ}_{i} + {θ}_{i} ) + cos ( α ) cos ( {β}_{i} ) & Formula ( 27 ) \\ [ Mathematical expression 20 ] & \\ [ \begin{matrix}{m}_{w 14}^{c} \\ {m}_{w 24}^{c} \\ {m}_{w 34}^{c}\end{matrix} ] = - [ \begin{matrix}{m}_{w 11}^{c} & {m}_{w 12}^{c} & {m}_{w 13}^{c} \\ {m}_{w 21}^{c} & {m}_{w 22}^{c} & {m}_{w 23}^{c} \\ {m}_{w 31}^{c} & {m}_{w 32}^{c} & {m}_{w 33}^{c}\end{matrix} ] {t}_{i}^{w} & Formula ( 28 )\end{matrix}$$

As described above, the velocity of mobile robot 100 calculated from the photographing result of first camera 210 depends on the orientation of housing 10 represented by α and γ and the height of housing 10 represented by h.

The translational velocity of mobile robot 100 calculated from the photographing result of first camera 210 depends on design parameters rᵢ, Ψᵢ, bᵢ, βᵢ, and θᵢ of mobile robot 100. These design parameters are values determined by size, layout, and the like of mobile robot 100, and are predetermined known values.

Therefore, if α, γ, and h can be acquired, calculator 110 can accurately calculate the translational velocity of mobile robot 100 (i.e., velocity in a direction along the predetermined reference axis) using the information (i.e., the first lower image) acquired from first camera 210. Furthermore, calculator 110 acquires α, γ, and h, and calculates the angular velocity (i.e., rotational velocity from the predetermined reference axis), so that the combined velocity of mobile robot 100 at a predetermined time can be accurately calculated from the translational velocity and the angular velocity.

In the present exemplary embodiment, three distance measurement sensors 240 are used to measure the distance between housing 10 and the floor surface.

Here, it is assumed that Nd (≥3) pieces of distance measurement sensors 240 are attached to housing 10 at positions (xᵢ, yᵢ, zᵢ) in the reference frame of mobile robot 100.

Note that the number of distance measurement sensors is not particularly limited as long as it is three or more. In the present exemplary embodiment, three distance measurement sensors are provided in the mobile robot.

For example, the i-th distance measurement sensor 240 measures distance (hᵢ) between housing 10 and the floor surface.

Note that, in order to simplify the following description, it is assumed that the i-th distance measurement sensor 240 measures hᵢ in the Z-axis direction.

Distance measurement sensor 240 may be inclined with respect to the vertical direction due to a design or manufacturing allowance. In this case, when an allowable error is known in advance, calculator 110 may correct hᵢ acquired from distance measurement sensor 240 based on the allowable error.

Calculator 110 can calculate h, α, and γ from the condition of 1≤i≤Nd based on hᵢ acquired from each of i pieces of distance measurement sensors 240.

For example, H and X are defined as in the following Equations (29) and (30).

$$\begin{matrix}[ Mathematical Expression 21 ] \\ & \\ H = [ \begin{matrix}{h}_{1} - {Z}_{1} \\ ⋮ \\ {h}_{{N}_{d}} - {Z}_{{N}_{d}}\end{matrix} ] & Formula ( 29 ) \\ X = [ \begin{matrix}{x}_{1} & … & {x}_{{N}_{d}} \\ {y}_{1} & … & {y}_{{N}_{d}} \\ 1 & … & 1\end{matrix} ] & Formula ( 30 )\end{matrix}$$

As a result, the following Equation (31) is derived.

$$\begin{matrix}[ Mathematical Expression 22 ] & \\ [ \begin{matrix}{u}_{a} \\ {u}_{b} \\ {u}_{c}\end{matrix} ] = {( X {X}^{T} )}^{- 1} XH & Formula ( 31 )\end{matrix}$$

From Equation (31) described above, it can be seen that detector 230 includes three or more distance measurement sensors 240, so that XX^{T} can be calculated without being an irreversible matrix.

In addition, the following Equations (32) to (34) are derived from Equations (29) to (31) described above.

[Mathematical Expression 23]

\hat{α}=arctan(\sqrt{uₐ²+u_{b}²}) Formula (32)

\hat{γ}=arctan₂(u_{b},−uₐ) Formula (33)

ĥ=u_{c} cos(α) Formula (34)

In addition, the following Equation (35) is derived from the reciprocal of Equation (12) described above.

$$\begin{matrix}[ Mathematical Expression 24 ] & \\ [ \begin{matrix}{v}_{i , x}^{w} \\ {v}_{i , y}^{w}\end{matrix} ] = {J}_{i}^{- 1} [ \begin{matrix}{v}_{i , x}^{c} \\ {v}_{i , y}^{c}\end{matrix} ] & Formula ( 35 )\end{matrix}$$

Now, suppose as shown in the following Mathematical Expression 25.

v_{i,z}^{w}=0 [Mathematical Expression 25]

The following Mathematical Expression 26 can be acquired from angular velocity sensor 250.

\vec{ω} [Mathematical Expression 26]

Finally, the following Equations (36) and (37) are derived from the reciprocal of Equation (11) described above.

[Mathematical Expression 27]

[symbol]

=ωp_{i,y}−v_{i,x}^{w} Formula (36)

[symbol]

=−ωp_{i,x}−v_{i,y}^{w} Formula (37)

As a result, the combined velocity of mobile robot 100 is calculated.

Note that a hat operator above vₓ and v_{y} in Equations (36) and (37) described above is a notation used to denote an estimated value. The same applies to the hat operators used below.

### [Process Procedure]

Next, a process procedure of mobile robot 100 will be described.

### <Outline>

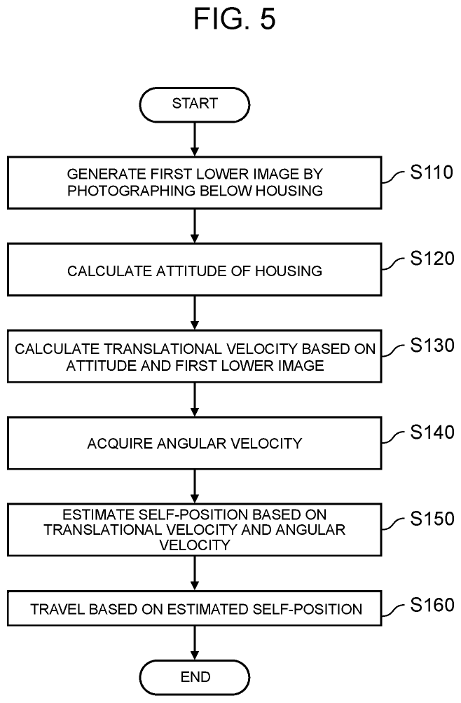

FIG. 5 is a flowchart illustrating an outline of the process procedure in mobile robot 100 according to the first exemplary embodiment. First, in the flowchart described below, it is assumed that mobile robot 100 has been able to estimate the self-position of mobile robot 100 in the predetermined space before step S110 (or step S111 or step S123 described later). Hereinafter, this self-position is referred to as a first self-position. In addition, first camera 210 generates the first lower image at the first self-position by photographing below housing 10. First camera 210 outputs the first lower image generated to calculator 110. Controller 130 controls driver 140 to cause mobile robot 100 to travel from the first self-position along a travel route stored in storage unit 150, for example.

First camera 210 generates another first lower image by photographing below housing 10 while mobile robot 100 is traveling (step S110). First camera 210 outputs the first lower image generated to calculator 110.

Next, calculator 110 calculates the attitude of housing 10 (step S120). In the present exemplary embodiment, calculator 110 acquires a distance from each of three distance measurement sensors 240. Calculator 110 calculates orientation (α and γ) and height (h) of housing 10 indicating the attitude of housing 10 from the acquired distance.

Next, calculator 110 calculates the translational velocity of mobile robot 100 based on the attitude of housing 10 and the first lower image (step S130). Specifically, calculator 110 calculates the translational velocity of mobile robot 100 based on the attitude of housing 10, the first lower image generated at the first self-position, and the first lower image generated during traveling of mobile robot 100.

Next, calculator 110 acquires the angular velocity (step S140). In the present exemplary embodiment, calculator 110 acquires the angular velocity from angular velocity sensor 250 while mobile robot 100 is traveling.

Next, estimator 121 estimates the self-position of mobile robot 100 in the predetermined space based on the translational velocity and the angular velocity (step S150). Specifically, estimator 121 estimates the self-position of mobile robot 100 after moving from the first self-position in the predetermined space based on the translational velocity, the angular velocity, and the first self-position. Hereinafter, this self-position is referred to as a second self-position. For example, estimator 121 calculates coordinates of the second self-position based on the coordinates of the first self-position, the time when mobile robot 100 is located at the first self-position, the translational velocity and the angular velocity calculated by calculator 110, and time after the movement, more specifically, time when mobile robot 100 is located at the second self-position. Alternatively, estimator 121 calculates the coordinates of the second self-position based on the coordinates of the first self-position, the translational velocity and the angular velocity calculated by calculator 110, and movement time from the first self-position to the second self-position.

Mobile robot 100 may include a clocking part such as a real time clock (RTC) in order to acquire time.

Next, controller 130 controls driver 140 to cause mobile robot 100 to travel based on the self-position estimated by estimator 121 (step S160). Specifically, controller 130 controls driver 140 to cause mobile robot 100 to further travel from the second self-position along the travel route stored in storage unit 150, for example.

### Specific Example

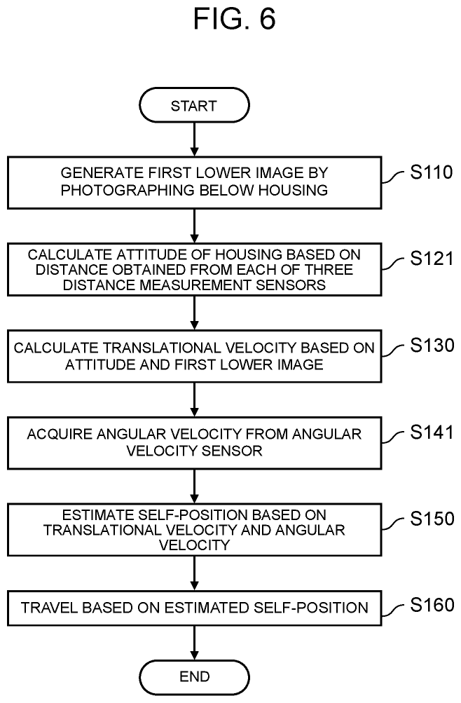

FIG. 6 is a flowchart illustrating a process procedure in mobile robot 100 according to the first exemplary embodiment.

First, while mobile robot 100 is traveling, first camera 210 generates the first lower image by photographing below housing 10 (step S110).

Next, calculator 110 calculates the attitude of housing 10 based on the distance obtained from each of three distance measurement sensors 240 (step S121). Specifically, calculator 110 calculates the orientation (α and γ) and the height (h) of housing 10 indicating the attitude of housing 10 from the obtained distance.

Next, calculator 110 calculates the translational velocity of mobile robot 100 based on the attitude of housing 10 and the first lower image (step S130).

Next, calculator 110 acquires the angular velocity from angular velocity sensor 250 while mobile robot 100 is traveling (step S141).

Next, estimator 121 estimates the self-position of mobile robot 100 in the predetermined space based on the translational velocity and the angular velocity (step S150).

Next, controller 130 controls driver 140 to cause mobile robot 100 to travel based on the self-position estimated by estimator 121 (step S160).

### [Effects]

As described above, mobile robot 100 according to the first exemplary embodiment is the mobile robot that autonomously travels in the predetermined space. Mobile robot 100 includes housing 10, first camera 210 attached to housing 10 and configured to generate the first lower image by photographing below housing 10, detector 230 attached to housing 10 and configured to detect the attitude of housing 10, calculator 110 configured to calculate the velocity of mobile robot 100 (the above-described translational velocity) based on the attitude of housing 10 and the first lower image, estimator 121 configured to estimate the self-position of mobile robot 100 in the predetermined space based on the velocity calculated by calculator 110, and controller 130 configured to control mobile robot 100 to travel based on the self-position estimated by estimator 121.

As described above, by calculating the attitude and the velocity of housing 10, calculator 110 indirectly calculates the attitude and velocity of first camera 210 attached to housing 10 so that the relative attitude and positional relationship with housing 10 do not change. According to this configuration, since calculator 110 can correct the attitude of first camera 210, it is possible to calculate a more accurate velocity of first camera 210. In other words, calculator 110 can calculate a more accurate velocity of housing 10, in other words, a velocity of mobile robot 100. As a result, mobile robot 100 can accurately calculate the self-position using the accurately calculated velocity.

Still more, for example, detector 230 includes three or more distance measurement sensors 240 that each measure the distance between the floor surface on which mobile robot 100 travels and housing 10. In this case, for example, calculator 110 calculates the attitude of housing 10 based on the distance acquired from each of the three or more distance measurement sensors 240.

According to this configuration, calculator 110 can calculate the attitude of housing 10 by simple calculation process based on the distance obtained from each of the three or more distance measurement sensors 240.

Still more, for example, mobile robot 100 further includes an angular velocity sensor 250 attached to housing 10 and configured to measure the angular velocity of mobile robot 100. In this case, estimator 121 estimates the self-position based on the angular velocity and the velocity (i.e., the combined velocity described above) of mobile robot 100.

According to this configuration, calculator 110 can acquire the angular velocity of mobile robot 100 with a simple configuration, and estimator 121 can estimate the self-position with higher accuracy. Furthermore, estimator 121 can accurately estimate the orientation of mobile robot 100 at the self-position, more specifically, the orientation of housing 10. According to this configuration, mobile robot 100 can start traveling in a more appropriate direction when further traveling from the self-position.

### Second Exemplary Embodiment

Hereinafter, a mobile robot according to a second exemplary embodiment will be described. In the description of the second exemplary embodiment, differences from mobile robot 100 according to the first exemplary embodiment will be mainly described. Configurations and process procedure substantially similar to those of mobile robot 100 will be denoted by the same reference marks, and the description thereof may be partially simplified or omitted.

### [Configuration]

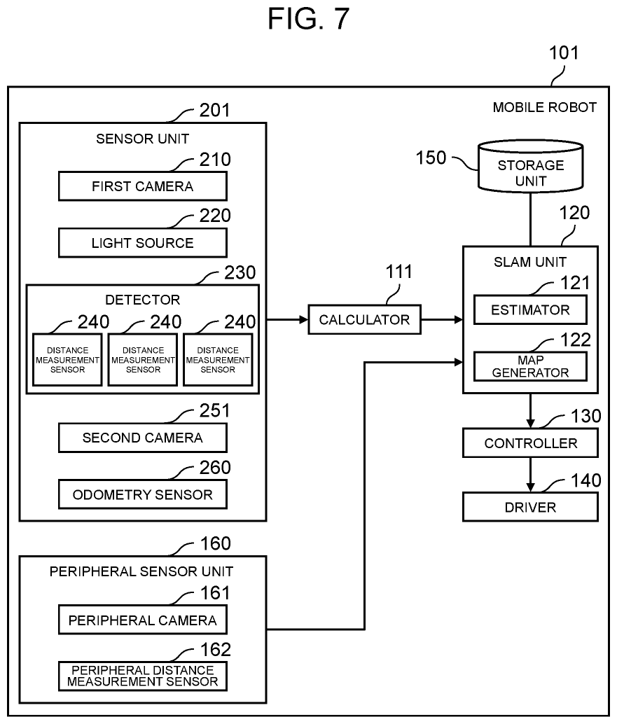

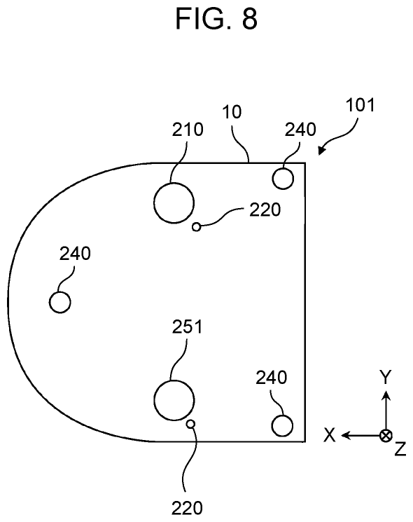

FIG. 7 is a block diagram illustrating a configuration example of mobile robot 101 according to the second exemplary embodiment. FIG. 8 is a schematic view illustrating an example of an arrangement layout of each component of sensor unit 201 included in mobile robot 101 according to the second exemplary embodiment. Note that FIG. 8 illustrates the arrangement layout of a part of sensor unit 201 as viewed from the bottom surface side of housing 10, and illustration of other components of sensor unit 201, wheel 20, and the like is omitted.

Mobile robot 101 calculates a translational velocity based on three distance measurement sensors 240 and one image, and calculates an angular velocity based on two images.

Mobile robot 101 includes sensor unit 201, peripheral sensor unit 160, calculator 111, SLAM unit 120, controller 130, driver 140, and storage unit 150.

Sensor unit 201 is a sensor group that detects information for calculating the velocity of mobile robot 101. In the present exemplary embodiment, sensor unit 201 includes first camera 210, light source 220, detector 230, second camera 251, and odometry sensor 260.

Second camera 251 is a camera that is attached to housing 10 and generates an image by photographing below housing 10. Hereinafter, this image is referred to as a second lower image. Second camera 251 periodically and repeatedly outputs the second lower image generated to calculator 111. Second camera 251 only needs to be able to detect a light distribution based on light source 220 described later. The wavelength, the number of pixels, and the like of light to be detected by second camera 251 are not particularly limited.

In the present exemplary embodiment, the configuration example in which mobile robot 101 includes two cameras of first camera 210 and second camera 251 is illustrated, but the present disclosure is not limited to this configuration. Mobile robot 101 may include three or more cameras.

Note that FIG. 8 illustrates two light sources 220 to show the configuration in which one light source 220 corresponds to first camera 210 and another light source 220 corresponds to second camera 251. However, the number of light sources 220 included in sensor unit 201 may be one.

As illustrated in FIG. 8, when housing 10 is viewed from the bottom, first camera 210 and second camera 251 are attached side by side at the center of housing 10, for example.

First camera 210, detector 230, second camera 251, and odometry sensor 260 operate in synchronization with each other by a processor such as calculator 111, for example, and periodically and repeatedly output each piece of information at the same time to calculator 111.

Calculator 111 is a processor that calculates the velocity (translational velocity) of mobile robot 101 based on the attitude of housing 10 and the first lower image. In the present exemplary embodiment, calculator 111 calculates the angular velocity of mobile robot 101 based on the first lower image and the second lower image. A specific method of calculating the angular velocity will be described later.

In addition, calculator 111 calculates a velocity in consideration of a direction in which mobile robot 101 has traveled, i.e., a combined velocity, from the calculated translational velocity and the calculated angular velocity. Calculator 111 outputs the calculated combined velocity to SLAM unit 120. Note that calculator 111 may output the calculated translational velocity and the calculated angular velocity to SLAM unit 120 without combining the respective pieces of information.

### [Velocity Calculation Process]

Next, a specific calculation method of the combined velocity of mobile robot 101 will be described. In the following description, it is assumed that mobile robot 101 includes Nc (≥2) units of cameras that photograph below housing 10. The Nc units of cameras include both first camera 210 and second camera 251.

First, the following Mathematical Expression 28 can be calculated from above Equation (35).

vᵢ^{w} [Mathematical Expression 28]

Next, matrix A is defined as shown in the following Equation (38).

$$\begin{matrix}[ Mathematical Expression 29 ] & \\ A = [ \begin{matrix}1 & 0 & & - {p}_{1 , y} \\ 0 & 1 & & {p}_{1 , x} \\ & & ⋮ & \\ 1 & 0 & & - {p}_{{N}_{c} , y} \\ 0 & 1 & & {p}_{{N}_{c} , x}\end{matrix} ] & Formula ( 38 )\end{matrix}$$

According to the above, the translational velocity and the angular velocity of mobile robot 101 can be calculated from the following Equation (39).

$$\begin{matrix}[ Mathematical Expression 30 ] & \\ [ \begin{matrix} \\ \\ \hat{ω}\end{matrix} ] = - {( {A}^{T} A )}^{- 1} {A}^{T} [ \begin{matrix}{v}_{1 , x}^{w} \\ {v}_{1 , y}^{w} \\ ⋮ \\ {v}_{{N}_{c} , x}^{w} \\ {v}_{{N}_{c} , y}^{w}\end{matrix} ] & Formula ( 39 )\end{matrix}$$

In this way, calculator 111 can calculate the translational velocity and the angular velocity based on the information (images) acquired from two or more cameras by using the above-described Equation (39). More specifically, calculator 111 can calculate the angular velocity of mobile robot 101 based on a change in a relative positional relationship between before and after traveling of images acquired from two or more cameras.

### [Process Procedure]

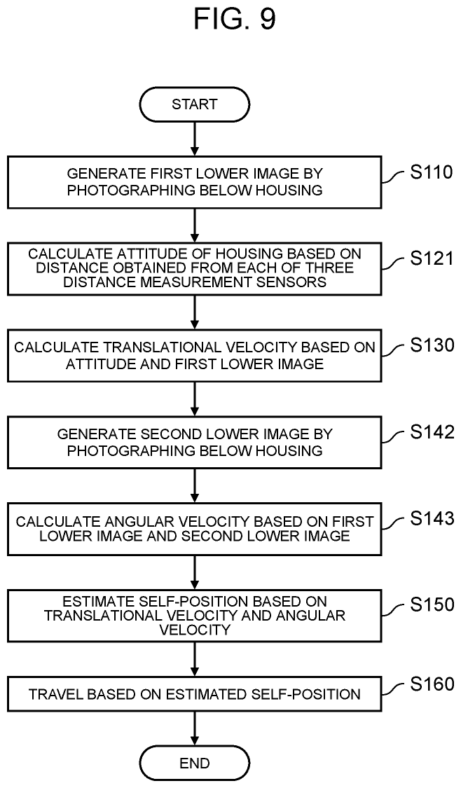

FIG. 9 is a flowchart illustrating a process procedure in mobile robot 101 according to the second exemplary embodiment.

First, while mobile robot 101 is traveling, first camera 210 generates the first lower image by photographing below housing 10 (step S110).

Next, calculator 111 calculates the attitude of housing 10 based on the distance obtained from each of the three distance measurement sensors 240 (step S121). Specifically, calculator 111 calculates the orientation (α and γ) and the height (h) of housing 10 indicating the attitude of housing 10 from the acquired distance.

Next, calculator 111 calculates the translational velocity of mobile robot 101 based on the attitude of housing 10 and the first lower image (step S130).

Next, while mobile robot 101 is traveling, second camera 251 generates the second lower image by photographing below housing 10 (step S142). Second camera 251 outputs the generated second lower image to calculator 111.

Note that second camera 251 generates the second lower image by photographing below housing 10 at a point before mobile robot 101 starts traveling, i.e., at the first self-position described above. Also in this case, second camera 251 outputs the generated second lower image to calculator 111.

Note that the timing at which first camera 210 executes photographing and the timing at which second camera 251 executes photographing are the same. In other words, steps S110 and S142 are performed at the same time.

Next, calculator 111 calculates the angular velocity of mobile robot 101 based on the first lower image and the second lower image (step S143).

Next, estimator 121 estimates the self-position of mobile robot 101 in the predetermined space based on the translational velocity and the angular velocity (step S150).

Next, controller 130 controls driver 140 to cause mobile robot 101 to travel based on the self-position estimated by estimator 121 (step S160).

### [Effects]

As described above, mobile robot 101 according to the second exemplary embodiment includes housing 10, first camera 210, detector 230 (three or more distance measurement sensors 240), calculator 111 configured to calculate the velocity (translational velocity described above) of mobile robot 101 based on the attitude of housing 10 and the first lower image, estimator 121, and controller 130. Mobile robot 101 further includes second camera 251 attached to housing 10 and configured to generate the second lower image by photographing the lower side of mobile robot 101, specifically below housing 10. In this case, calculator 111 calculates the angular velocity of mobile robot 101 based on the first lower image and the second lower image.

According to this configuration, since calculator 111 calculates the angular velocity of mobile robot 101 based on the images obtained from the two cameras, the angular velocity of mobile robot 101 can be calculated with higher accuracy than using a device for detecting the angular velocity such as the IMU.

### Third Exemplary Embodiment

Hereinafter, a mobile robot according to a third embodiment will be described. Note that, in the description of the third exemplary embodiment, differences from mobile robots 100 and 101 according to the first and second exemplary embodiments will be mainly described. Configurations and process procedures substantially similar to those of mobile robots 100 and 101 will be denoted by the same reference marks, and description thereof may be partially simplified or omitted.

### [Configuration]

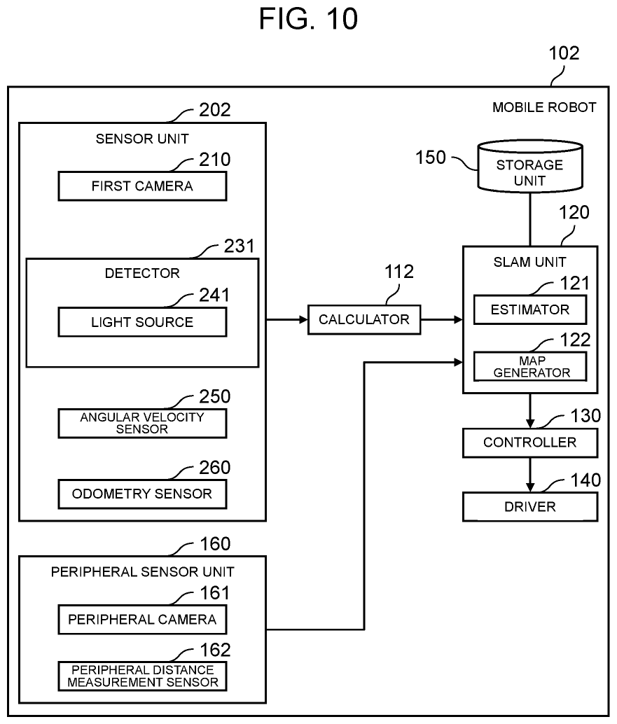

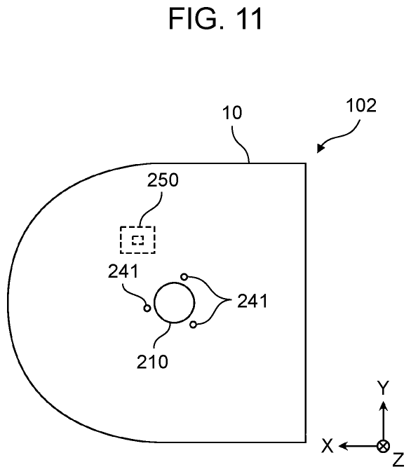

FIG. 10 is a block diagram illustrating a configuration example of mobile robot 102 according to the third exemplary embodiment. FIG. 11 is a schematic view illustrating an example of an arrangement layout of each component of sensor unit 202 included in mobile robot 102 according to the third exemplary embodiment. Note that FIG. 11 illustrates the arrangement layout of a part of sensor unit 202 as viewed from the bottom surface side of housing 10, and illustration of other components of sensor unit 202, wheel 20, and the like is omitted.

Mobile robot 102 calculates a translational velocity based on an image generated by detecting structured light, and measures an angular velocity using angular velocity sensor 250.

Mobile robot 102 includes sensor unit 202, peripheral sensor unit 160, calculator 112, SLAM unit 120, controller 130, driver 140, and storage unit 150.

Sensor unit 202 is a sensor group that detects information for calculating the velocity of mobile robot 102. In the present exemplary embodiment, sensor unit 202 includes first camera 210, detector 231, angular velocity sensor 250, and odometry sensor 260.

In addition, detector 231 includes light source 241 that emits the structured light toward the lower side of mobile robot 102. In other words, light source 241 is a structured light source. First camera 210 generates a first lower image by detecting reflected light of structured light emitted from light source 241 and reflected on a floor surface on which mobile robot 102 travels.

In the present exemplary embodiment, first camera 210 is a telecentric camera.

The structured light is light emitted in a predetermined specific direction, and has a specific light distribution on a projection plane of the light.

Light source 241 includes, for example, three laser light sources. Then, as illustrated in FIG. 11, when housing 10 is viewed from the bottom, the three laser light sources included in light source 241 are arranged to surround first camera 210, for example. Each of laser beams emitted from the three laser light sources is emitted toward the floor surface in a predetermined direction.

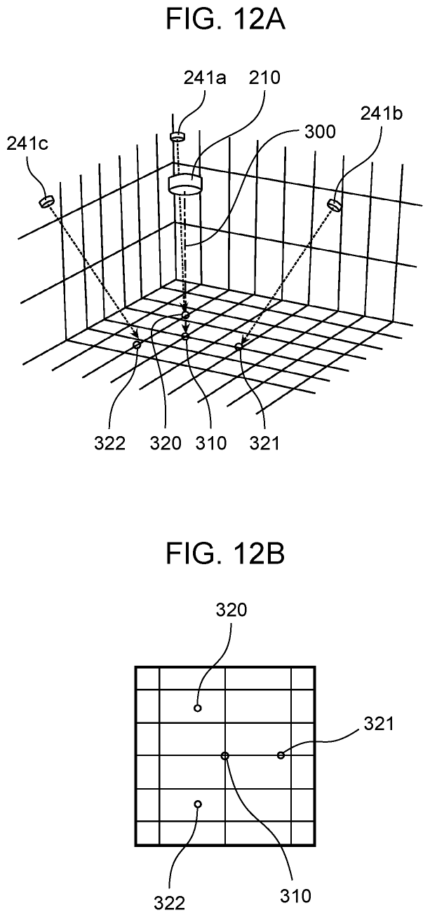

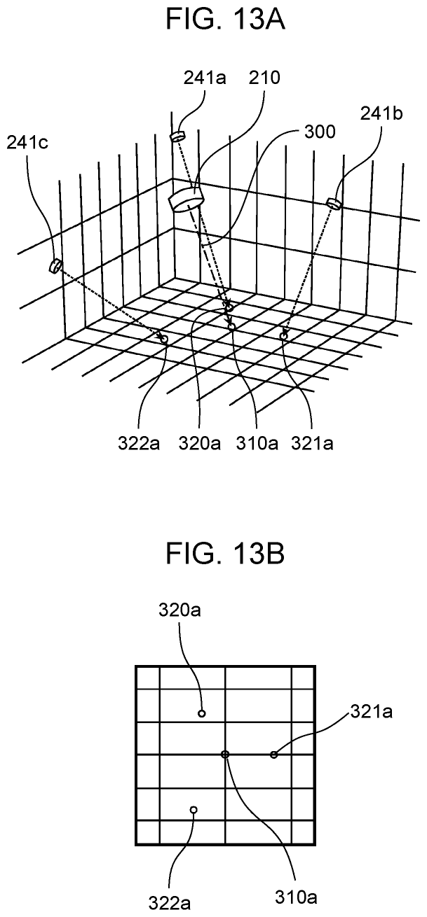

FIGS. 12A to 13B are diagrams for describing the structured light. Note that FIG. 12B is a diagram corresponding to FIG. 12A, and is a diagram illustrating each irradiation position of the structured light in a case where the photographing center of first camera 210 is located at the center (origin). Furthermore, FIG. 13B is a diagram corresponding to FIG. 13A, and is a diagram illustrating each irradiation position of the structured light in a case where the photographing center of first camera 210 is located at the center (origin).

FIGS. 12A and 12B schematically illustrate first camera 210, laser light sources 241a, 241b, and 241c of light source 241, and light irradiation positions of the structured light on the floor surface when housing 10 is not inclined with respect to the floor surface. On the other hand, FIGS. 13A and 13B schematically illustrate laser light sources 241a, 241b, and 241c of light source 241, first camera 210, and light irradiation positions of the structured light on the floor surface when housing 10 is inclined at a predetermined angle with respect to the floor surface. Therefore, in the state illustrated in FIGS. 13A and 13B, the optical axis of first camera 210 and the emission directions of laser light sources 241a, 241b, and 241c of light source 241 are inclined from the state illustrated in FIGS. 12A and 12B, respectively.

As illustrated in FIG. 12A, the structured light of laser beams emitted from laser light sources 241a, 241b, 241c includes at least three laser beams having optical axes inclined with respect to the optical axis of first camera 210.

These three laser beams may be emitted from independent light sources as described in the present exemplary embodiment, or may be generated by dividing a laser beam emitted from a single light source into a plurality of beams by an optical system such as a mirror, a half mirror, or a beam splitter.

As illustrated in FIG. 12B, irradiation positions 320, 321, and 322, which are positions on the floor surface irradiated with the laser beam, can acquire coordinates from the image generated by first camera 210. These positions depend on the height (h) of housing 10 and the orientation (α and γ) of housing 10. In other words, these positions depend on the attitude of housing 10.

For example, when housing 10 is inclined with respect to the floor surface, as shown in FIG. 13A, irradiation positions 320a, 321a, and 322a on the floor surface of the laser beams emitted from laser light sources 241a, 241b, 241c move from irradiation positions 320, 321, 322 shown in FIG. 12A.

For example, it is assumed that photographing center position 310a, which is an intersection of the optical axis of first camera 210 and the floor surface, and irradiation positions 320a, 321a, and 322a are moved so as to overlap photographing center position 310a with photographing center position 310 illustrated in FIG. 12B without changing the positional relationship therebetween. In this case, for example, irradiation position 320a moves to the left with respect to irradiation position 320. Further, irradiation position 321a moves to the lower right with respect to irradiation position 321. Further, irradiation position 322a moves to the lower left with respect to irradiation position 322.

As described above, the irradiation position of the light in the image generated by detecting the structured light depends on the attitude of housing 10. In other words, the attitude of housing 10 can be calculated based on the irradiation position of the light in the image generated by detecting the structured light.

First camera 210, detector 231, angular velocity sensor 250, and odometry sensor 260 operate in synchronization with each other by a processor such as calculator 112, and periodically and repeatedly output each piece of information at the same time to calculator 112.

Calculator 112 is a processor that calculates the velocity (translational velocity) of mobile robot 102 based on the attitude of housing 10 and the first lower image. In the present exemplary embodiment, calculator 112 calculates the attitude and the translational velocity of housing 10 based on the first lower image. First camera 210 generates this first lower image by detecting the reflected light of the structured light emitted from light source 241 and reflected on the floor surface on which mobile robot 102 travels. Similarly to calculator 110 according to the first exemplary embodiment, calculator 112 acquires the angular velocity of mobile robot 102 from angular velocity sensor 250. Calculator 112 calculates the combined velocity of mobile robot 102 from the calculated translational velocity and the angular velocity acquired from angular velocity sensor 250.

Calculator 112 outputs the calculated combined velocity to SLAM unit 120. Note that calculator 112 may output the calculated translational velocity and the angular velocity acquired from angular velocity sensor 250 to SLAM unit 120 without combining the respective pieces of information.

### [Velocity Calculation Process]

Next, a specific calculation method of the combined velocity of mobile robot 102 will be described. In the following description, it is assumed that mobile robot 102 includes Nl (≥3) pieces of laser light sources. In other words, in the following description, it is assumed that light source 241 has Nl pieces of laser light sources.

Note that angle η is formed by the optical axis of first camera 210 and the optical axis of the laser beam emitted from the i-th laser light source. However, it is assumed that 1≤i≤Nl.

In this case, in a top view of mobile robot 102, when distance lᵢ is between the i-th laser light source and the irradiation position on the floor surface of the laser beam emitted from the i-th laser light source, hᵢ can be calculated from the following Equation (40).

$$\begin{matrix}[ Mathematical Expression 31 ] & \\ {h}_{i} = \frac{{l}_{i}}{tan ( {η}_{i} )} & Formula ( 40 )\end{matrix}$$

Note that ηᵢ is a design parameter. Specifically, ηᵢ is an angle formed by the optical axis of first camera 210 and the optical axis of the i-th laser light source. Therefore, ηᵢ is a predetermined constant.

In the top view of mobile robot 102, the position of the i-th laser light source can be calculated based on design information such as a positional relationship of first camera 210 and the like arranged in housing 10.

In addition, h, α, and γ can be calculated from the above Equation (40) and the above Equations (29) to (37). Therefore, calculator 112 can calculate the translational velocity of mobile robot 102.

Note that, in this case, xᵢ, yᵢ, and zᵢ used in the above equations are calculated from the irradiation positions of the laser beams on a plane (plane parallel to the imaging plane) of first camera 210 represented by the reference frame of mobile robot 102.

In the present exemplary embodiment, the example in which the structured light forms the three light spots on the floor surface is described. However, the structured light does not need to be N discrete points (i.e., a plurality of light spots) on the floor surface. For example, the structured light may be annular light or light in which the shape of the light spot changes on the floor surface according to the height and orientation of mobile robot 102.

In the above description, the orientation and height of housing 10 and the translational velocity of mobile robot 102 are calculated based on the information (image) obtained from one camera (i.e., first camera 210). For example, mobile robot 102 may include one camera and may be configured to switch on and off light source 241 that emits the structured light.

According to this configuration, the height and orientation of housing 10 may be calculated based on an image generated by detecting the structured light, and the velocity of mobile robot 102 may be calculated based on an image generated by detecting the structured light and an image generated by detecting light other than the structured light. The light other than the structured light is, for example, light from light source 220 that emits light other than the structured light.

In addition, in a case where first camera 210 detects the structured light to generate an image, mobile robot 102 may be moving or may be stopped.

Still more, mobile robot 102 may include two cameras that detect the structured light. In other words, mobile robot 102 may include two sets of light source 241 and first camera 210, which is a telecentric camera. For example, one set generates an image for calculating the translational velocity of mobile robot 102 by calculator 112, and the other set generates an image for calculating the attitude of mobile robot 102 by calculator 112. In this case, each camera can be regarded as a standalone sensor that outputs information on the state of mobile robot 102.

### [Process Procedure]

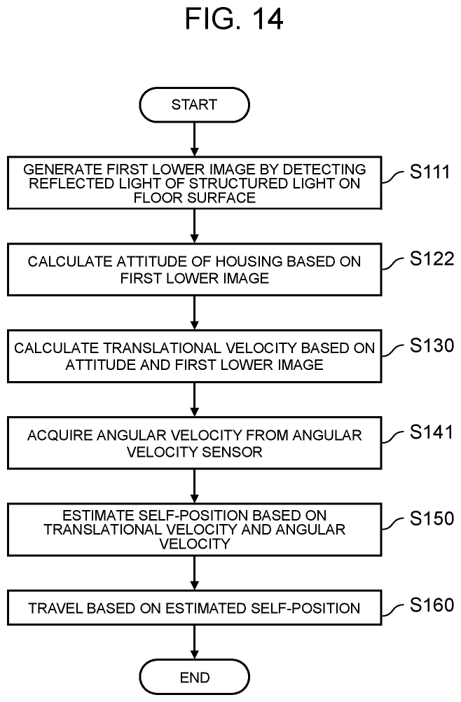

FIG. 14 is a flowchart illustrating a process procedure in mobile robot 102 according to the third exemplary embodiment.

First, while mobile robot 102 is traveling, first camera 210 detects reflected light of the structured light emitted from light source 241 and reflected on the floor surface on which mobile robot 102 travels. As a result, first camera 210 generates the first lower image (step S111).

Next, calculator 112 calculates the attitude of housing 10 based on the first lower image generated by first camera 210 (step S122). First camera 210 generates this first lower image by detecting the reflected light of the structured light emitted from light source 241 and reflected on the floor surface on which mobile robot 102 travels. Calculator 112 calculates the orientation (α and γ) of housing 10 and the height (h) indicating the attitude of housing 10, based on the acquired first lower image.

Next, calculator 112 calculates the translational velocity of mobile robot 102 based on the attitude of housing 10 and the first lower image (step S130).

Then, calculator 112 acquires the angular velocity from angular velocity sensor 250 while mobile robot 102 is traveling (step S141).

Next, estimator 121 estimates the self-position of mobile robot 102 in the predetermined space based on the translational velocity and the angular velocity (step S150).

Next, controller 130 controls driver 140 to cause mobile robot 102 to travel based on the self-position estimated by estimator 121 (step S160).

### [Effects]

As described above, mobile robot 102 according to third exemplary embodiment includes housing 10, first camera 210, detector 231, calculator 112 configured to calculate the velocity (translational velocity described above) of mobile robot 102 based on the attitude of housing 10 and the first lower image, estimator 121, and controller 130. In addition, detector 231 includes light source 241 that emits the structured light toward the lower side of mobile robot 102. In this configuration, first camera 210 generates the first lower image by detecting the reflected light of the structured light emitted from the light source 241 and reflected on the floor surface on which mobile robot 102 travels. Calculator 112 calculates the attitude of housing 10 and the velocity of mobile robot 102 based on the first lower image that first camera 210 generates by detecting the reflected light of the structured light emitted from the light source 241 and reflected on the floor surface on which mobile robot 102 travels.

According to this configuration, for example, calculator 112 can calculate the attitude of housing 10 without using the three distance measurement sensors 240 included in detector 230 of mobile robot 100 according to the first exemplary embodiment. Therefore, the configuration of mobile robot 102 can be simplified.

### Fourth Exemplary Embodiment

A mobile robot according to a fourth embodiment will be described below. In the description of the fourth exemplary embodiment, differences from mobile robots 100 to 102 according to the first to third exemplary embodiments will be mainly described. Configurations and process procedures substantially similar to those of mobile robots 100 to 102 will be denoted by the same reference marks, and the description thereof may be partially simplified or omitted.

### [Configuration]

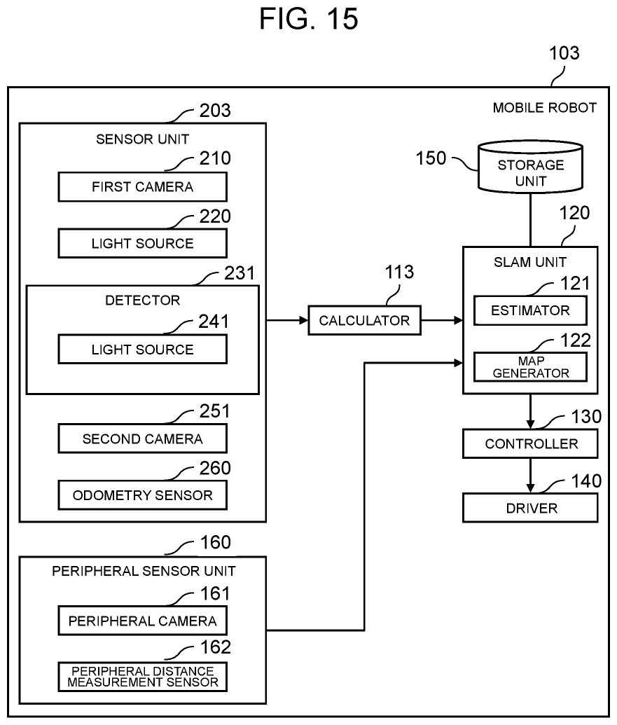

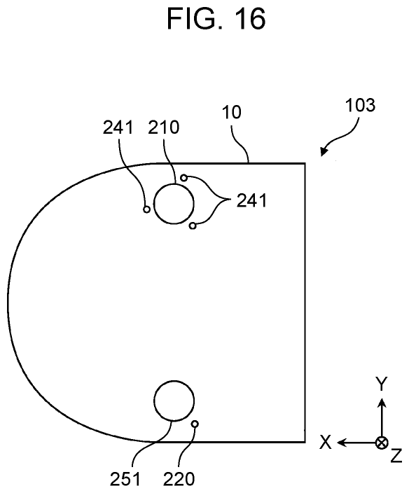

FIG. 15 is a block diagram illustrating a configuration example of mobile robot 103 according to the fourth exemplary embodiment. FIG. 16 is a schematic view illustrating an example of an arrangement layout of each component of sensor unit 203 included in mobile robot 103 according to the fourth exemplary embodiment. Note that FIG. 16 illustrates a diagram of the arrangement layout of a part of sensor unit 203 as viewed from the bottom surface side of housing 10, and illustration of other components of sensor unit 203, wheel 20, and the like is omitted.

Mobile robot 103 calculates a translational velocity based on an image generated by detecting structured light, and calculates an angular velocity based on two images generated by different cameras.

Mobile robot 103 includes sensor unit 203, peripheral sensor unit 160, calculator 113, SLAM unit 120, controller 130, driver 140, and storage unit 150.

Sensor unit 203 is a sensor group that detects information for calculating the velocity of mobile robot 103. In the present exemplary embodiment, sensor unit 203 includes first camera 210, detector 231, second camera 251, and odometry sensor 260.

In addition, detector 231 includes light source 241 that emits structured light toward the lower side of mobile robot 103. In other words, light source 241 is a structured light source. First camera 210 generates a first lower image by detecting reflected light of the structured light emitted from light source 241 and reflected on a floor surface on which mobile robot 103 travels.

In the present exemplary embodiment, first camera 210 is a telecentric camera.

Light source 241 includes, for example, three laser light sources. Then, as illustrated in FIG. 16, when housing 10 is viewed from the bottom, the three laser light sources included in light source 241 are arranged to surround first camera 210, for example. In addition, when housing 10 is viewed from the bottom, first camera 210 and second camera 251 are attached side by side, for example, at the center of housing 10.

First camera 210, detector 231, second camera 251, and odometry sensor 260 operate in synchronization with each other by a processor such as calculator 113, for example, and periodically and repeatedly output each piece of information at the same time to the calculator 113.

Calculator 113 is a processor that calculates the velocity (translational velocity) of mobile robot 103 based on the attitude of housing 10 and the first lower image. In the present exemplary embodiment, calculator 113 calculates the attitude and translational velocity of housing 10 based on the first lower image, similarly to calculator 112 according to the third embodiment. First camera 210 generates this first lower image by detecting reflected light of the structured light emitted from the light source 241 and reflected on the floor surface on which mobile robot 103 travels.

Specifically, calculator 113 calculates height hᵢ from the above Equation (39) based on the image generated by detecting the structured light. However, it is assumed that 1≤i≤Nl and Nl≥3. Furthermore, for example, calculator 113 calculates the velocity of each of the two cameras, that is, first camera 210 and second camera 251, by using the above-described Equations (29) to (35).

In addition, calculator 113 calculates the angular velocity of mobile robot 103 based on the first lower image and the second lower image, similarly to calculator 111 according to the second exemplary embodiment.

Calculator 113 calculates the combined velocity of mobile robot 103 from the calculated translational velocity and the calculated angular velocity. Specifically, the angular velocity of mobile robot 103 is calculated from the velocity of each of the two cameras calculated using the above Equations (29) to (35) and the above Equation (39).

Calculator 113 outputs the calculated combined velocity to SLAM unit 120. Note that calculator 113 may output the calculated translational velocity and the calculated angular velocity to SLAM unit 120 without combining the respective pieces of information.

Note that FIG. 16 illustrates the configuration example in which light source 241 that emits the structured light is arranged only in the vicinity of one (first camera 210) of first camera 210 and second camera 251, but the present disclosure is not limited to this configuration. Light source 241 that emits the structured light may be disposed in the vicinity of each of first camera 210 and second camera 251. The vicinity is a range in which first camera 210 or second camera 251 can appropriately detect light from light source 241 reflected on the floor surface.

According to this configuration, since calculator 113 can calculate the height of housing 10 (h described above) and the attitude of housing 10 (a and y described above) in each of first camera 210 and second camera 251, the translational velocity and the angular velocity of mobile robot 103 can be calculated more accurately.

Note that, in the configuration example illustrated in the present exemplary embodiment, mobile robot 103 includes two cameras, which are first camera 210 and second camera 251, but the present disclosure is not limited to this configuration. Mobile robot 103 may include three or more cameras that are attached to housing 10 and photograph below housing 10 to generate images.

According to this configuration, calculator 113 can calculate the velocity of mobile robot 103 with higher accuracy by calculating the velocity for each image obtained from each camera and setting an average value of a plurality of calculated velocities as the velocity of mobile robot 103.

### [Process Procedure]

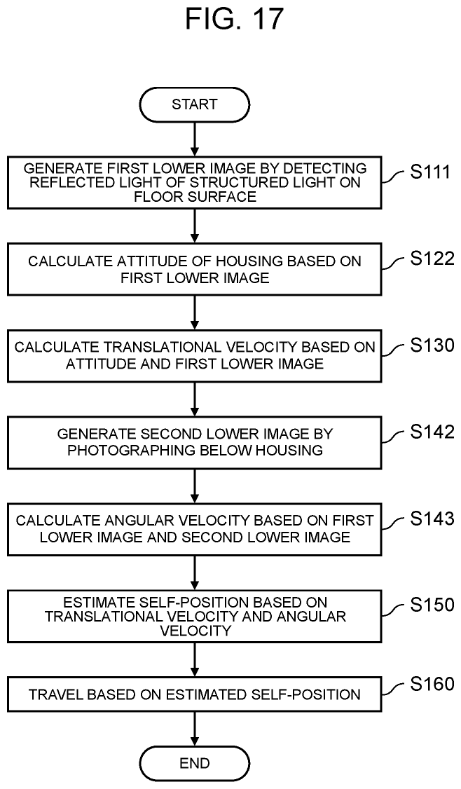

FIG. 17 is a flowchart illustrating a process procedure in mobile robot 103 according to the fourth exemplary embodiment.

First, while mobile robot 103 is traveling, first camera 210 detects reflected light of the structured light emitted from the light source 241 and reflected on the floor surface on which mobile robot 103 travels. As a result, first camera 210 generates the first lower image (step S111).

Next, calculator 113 calculates the attitude of housing 10 based on the first lower image generated by first camera 210 (step S122). First camera 210 generates this first lower image by detecting reflected light of the structured light emitted from the light source 241 and reflected on the floor surface on which mobile robot 103 travels. Calculator 113 calculates the orientation (α and γ) and the height (h) of housing 10, indicating the attitude of housing 10, based on the acquired first lower image.

Next, calculator 113 calculates the translational velocity of mobile robot 103 based on the attitude of housing 10 and the first lower image (step S130).

Next, while mobile robot 103 is traveling, second camera 251 generates the second lower image by photographing below housing 10 (step S142).

Next, calculator 113 calculates the angular velocity of mobile robot 103 based on the first lower image and the second lower image (step S143).

Next, estimator 121 estimates the self-position of mobile robot 103 in the predetermined space based on the translational velocity and the angular velocity (step S150).

Next, controller 130 controls driver 140 to cause mobile robot 103 to travel based on the self-position estimated by estimator 121 (step S160).

### [Effects]

As described above, mobile robot 103 according to the fourth exemplary embodiment includes housing 10, first camera 210, detector 231, calculator 113, estimator 121, controller 130, and second camera 251. In addition, detector 231 includes light source 241 that emits structured light. First camera 210 generates a first lower image by detecting reflected light of the structured light emitted from light source 241 and reflected on a floor surface on which mobile robot 103 travels. Calculator 113 calculates the attitude of housing 10 and the velocity of mobile robot 103 based on the first lower image that first camera 210 generates by detecting the reflected light of the structured light emitted from the light source 241 and reflected on the floor surface on which mobile robot 103 travels. The calculator 113 also calculates the angular velocity of mobile robot 103 based on the first lower image and the second lower image generated by second camera 251.

According to this configuration, similarly to mobile robot 102 according to the third exemplary embodiment, calculator 113 can calculate the attitude of housing 10 without using the three distance measurement sensors 240.

Therefore, the configuration of mobile robot 103 can be simplified. In addition, since calculator 113 calculates the angular velocity of mobile robot 103 based on the images obtained from the two cameras, similarly to calculator 111 according to the second exemplary embodiment, the angular velocity of mobile robot 103 can be calculated with higher accuracy than using a device for detecting the angular velocity such as the IMU.

As described above, the components of the mobile robot according to each exemplary embodiment may be arbitrarily combined.

### Fifth Exemplary Embodiment

Hereinafter, a mobile robot according to a fifth exemplary embodiment will be described. In the description of the fifth exemplary embodiment, differences from mobile robots 100 to 103 according to the first to fourth exemplary embodiments will be mainly described. Configurations and process procedures substantially similar to those of mobile robots 100 to 103 will be denoted by the same reference marks, and the description thereof may be partially simplified or omitted.

### [Configuration]

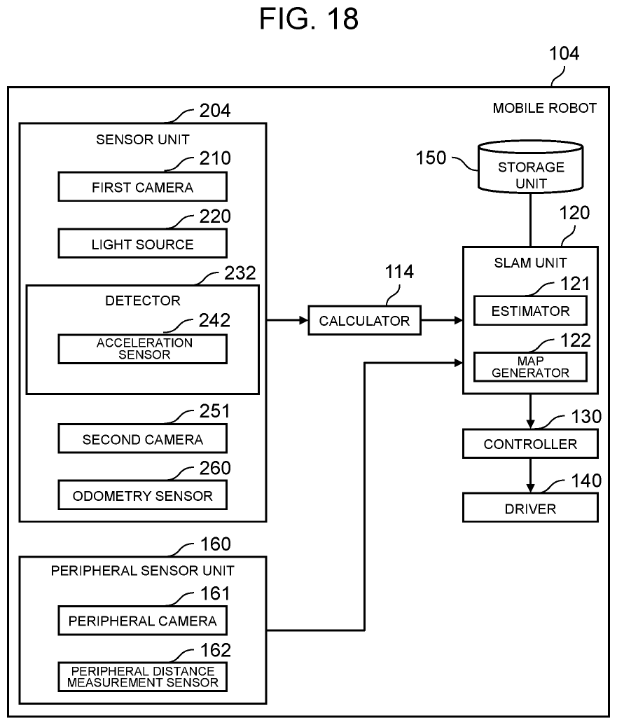

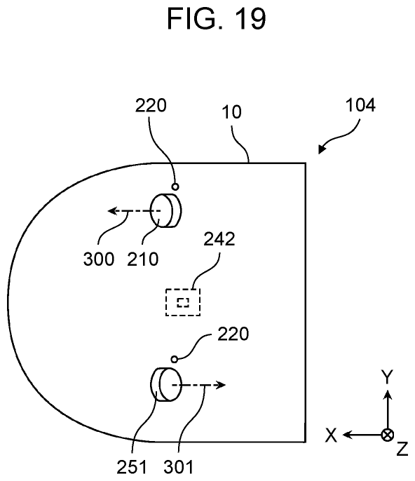

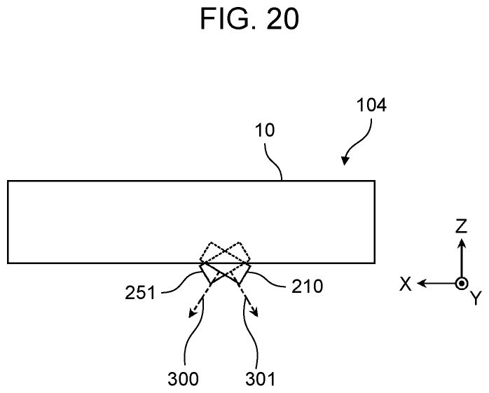

FIG. 18 is a block diagram illustrating a configuration example of mobile robot 104 according to the fifth exemplary embodiment. FIG. 19 is a schematic view illustrating an example of an arrangement layout of each component of sensor unit 204 included in mobile robot 104 according to the fifth exemplary embodiment. Note that FIG. 19 illustrates the arrangement layout of a part of sensor unit 204 as viewed from the bottom surface side of housing 10, and illustration of other components of sensor unit 204, wheel 20, and the like is omitted. FIG. 20 is a schematic view illustrating a photographing direction of the camera included in mobile robot 104 according to the fifth exemplary embodiment. Specifically, FIG. 20 is a schematic side view illustrating an optical axis direction of each of first camera 210 and second camera 251 included in mobile robot 104 according to the fifth exemplary embodiment.

Mobile robot 104 calculates an attitude of housing 10 based on acceleration of mobile robot 104 measured by an acceleration sensor. Furthermore, mobile robot 104 calculates a translational velocity based on the attitude and an image generated by photographing below housing 10. In addition, mobile robot 104 calculates an angular velocity based on two images generated by different cameras.

Mobile robot 104 includes sensor unit 204, peripheral sensor unit 160, calculator 114, SLAM unit 120, controller 130, driver 140, and storage unit 150.

Sensor unit 204 is a sensor group that detects information for calculating the velocity of mobile robot 104. In the present exemplary embodiment, sensor unit 204 includes first camera 210, light source 220, detector 232, second camera 251, and odometry sensor 260.

First camera 210 generates a first lower image by detecting reflected light of light emitted from light source 220 and reflected on a floor surface on which mobile robot 104 travels. Second camera 251 generates a second lower image by detecting reflected light of light emitted from light source 220 and reflected on the floor surface on which mobile robot 104 travels.

In addition, first camera 210 and second camera 251 are attached to housing 10 such that their optical axes are not parallel to each other. Specifically, as illustrated in FIG. 20, first camera 210 and second camera 251 are attached to housing 10 such that optical axis 300 of first camera 210 and optical axis 301 of second camera 251 are not parallel to each other. According to this configuration, Equation (55) described later does not become FTF0.

In the present exemplary embodiment, first camera 210 and second camera 251 are telecentric cameras.

Detector 232 includes acceleration sensor 242.

Acceleration sensor 242 is a sensor that measures acceleration of mobile robot 104. Specifically, acceleration sensor 242 is a sensor that measures the acceleration of mobile robot 104 in order to calculate a gravity direction of mobile robot 104. Acceleration sensor 242 is, for example, an IMU including an accelerometer. Acceleration sensor 242 periodically and repeatedly outputs measured acceleration (acceleration information) to calculator 114.

First camera 210, light source 220, detector 232, second camera 251, and odometry sensor 260 operate in synchronization with each other by a processor such as calculator 114, and periodically and repeatedly output each piece of information at the same time to calculator 114.

Calculator 114 is a processor that calculates the velocity (translational velocity) of mobile robot 104 based on the attitude of housing 10 and the first lower image.

In the present exemplary embodiment, calculator 114 calculates the attitude of mobile robot 104 based on the acceleration (acceleration information) acquired from acceleration sensor 242. Specifically, calculator 114 first calculates the gravity direction of mobile robot 104 based on acquired acceleration information. Next, calculator 114 calculates inclination (i.e., attitude) with respect to the floor surface from a predetermined attitude of housing 10 based on the calculated gravity direction. Specifically, calculator 114 acquires information indicating the sum of gravity and the acceleration of mobile robot 104 from acceleration sensor 242. Further, calculator 114 estimates the acceleration of mobile robot 104 from the odometry information. Calculator 114 calculates gravity (gravity direction) from a difference between the information indicating the above-mentioned sum and the estimated acceleration. Calculator 114 estimates the inclination of housing 10 based on how the calculated gravity appears on each axis (X-axis, Y-axis, and Z-axis) of acceleration sensor 242.

Still more, calculator 114 calculates the translational velocity of mobile robot 104 based on the calculated attitude of mobile robot 104, the first lower image, and the second lower image.

Furthermore, calculator 114 calculates the angular velocity of mobile robot 104 based on the first lower image and the second lower image, similarly to calculator 111 according to the second exemplary embodiment.

Calculator 114 calculates the combined velocity of mobile robot 104 from the calculated translational velocity and the calculated angular velocity.

Calculator 114 outputs the calculated combined velocity to SLAM unit 120. Note that calculator 114 may output the calculated translational velocity and the calculated angular velocity to SLAM unit 120 without combining the respective pieces of information.

### [Velocity Calculation Process]

Next, a specific calculation method of the combined velocity of mobile robot 104 will be described.

<Case where Camera is Telecentric Camera>

The following Equations (41) to (45) can be calculated based on Equations (8) to (10) described above.

$$\begin{matrix}[ Mathematical Expression 32 ] & \\ [ \begin{matrix}{p}_{i , x} \\ {p}_{i , y}\end{matrix} ] = [ \begin{matrix}h {p}_{i , m x} + {p}_{i , qx} \\ h {p}_{i , my} + {p}_{i , qy}\end{matrix} ] & Formula ( 41 ) \\ {p}_{i , mx} = {p}_{k} {p}_{i , mx}^{′} & Formula ( 42 ) \\ {p}_{i , q x} = {p}_{k} {p}_{i , qx}^{′} & Formula ( 43 ) \\ {p}_{i , my} = {p}_{k} {p}_{i , my}^{′} & Formula ( 44 ) \\ {p}_{i , qy} = {p}_{k} {p}_{i , qy}^{′} & Formula ( 45 )\end{matrix}$$

Note that p in each of the above Equations (41) to (45) is calculated by the following Equations (46) to (50), respectively.

$$\begin{matrix} [ Mathematical Expression 33 ] & \\ {p}_{k} = \frac{1}{sin ( α ) sin ( {β}_{i} ) cos ( - γ + ψ + {θ}_{i} ) - cos ( α ) cos ( {β}_{i} )} & Formula ( 46 ) \\ {p}_{i , mx}^{′} = - 2 {sin}^{2} ( \frac{α}{2} ) sin ( {β}_{i} ) sin ( γ ) cos ( - γ + {ψ}_{i} + {θ}_{i} ) + sin ( α ) sin ( γ ) cos ( {β}_{i} ) + sin ( {β}_{i} ) sin ( {ψ}_{i} + {θ}_{i} ) & Formula ( 47 ) \\ [ Mathematical Expression 34 ] & \\ {p}_{i , qx}^{′} = - 2 b {sin}^{2} ( \frac{α}{2} ) sin ( {β}_{i} ) sin ( γ ) cos ( α ) cos ( - γ + {ψ}_{i} + {θ}_{i} ) + b {sin}^{2} ( α ) sin ( {β}_{i} ) sin ( γ ) cos ( - γ + {ψ}_{i} + {θ}_{i} ) + b sin ( {β}_{i} ) sin ( {ψ}_{i} + {θ}_{i} ) cos ( α ) + 2 {r}_{i} {sin}^{2} ( \frac{α}{2} ) sin ( γ ) sin ( γ - {ψ}_{i} ) cos ( α ) cos ( {β}_{i} ) - {r}_{i} {sin}^{2} ( α ) sin ( γ ) sin ( γ - {ψ}_{i} ) cos ( {β}_{i} ) + {r}_{i} sin ( α ) sin ( {β}_{i} ) cos ( γ ) cos ( {θ}_{i} ) - {r}_{i} cos ( α ) cos ( {β}_{i} ) cos ( {ψ}_{i} ) & Formula ( 48 ) \\ [ Mathematical Expression 35 ] & \\ {p}_{i , m y}^{′} = 2 {sin}^{2} ( \frac{α}{2} ) sin ( {β}_{i} ) sin ( γ ) sin ( - γ + {ψ}_{i} + {θ}_{i} ) + 2 {sin}^{2} ( \frac{α}{2} ) sin ( {β}_{i} ) cos ( {ψ}_{i} + {θ}_{i} ) - sin ( α ) cos ( {β}_{i} ) cos ( γ ) - sin ( {β}_{i} ) cos ( {ψ}_{i} + {θ}_{i} ) & Formula ( 49 ) \\ [ Mathematical Expression 36 ] & \\ {p}_{i , q y}^{′} = 2 b {sin}^{2} ( \frac{α}{2} ) sin ( {β}_{i} ) sin ( γ ) sin ( - γ + {ψ}_{i} + {θ}_{i} ) cos ( α ) + 2 b {sin}^{2} ( \frac{α}{2} ) {sin}^{2} ( {β}_{i} ) cos ( α ) cos ( {ψ}_{i} + {θ}_{i} ) - b {sin}^{2} ( α ) sin ( {β}_{i} ) cos ( γ ) cos ( - γ + {ψ}_{t} + {θ}_{i} ) - b sin ( {β}_{i} ) cos ( α ) cos ( {ψ}_{i} + {θ}_{i} ) - 2 {r}_{i} {sin}^{2} ( \frac{α}{2} ) sin ( γ ) cos ( α ) cos ( {β}_{i} ) cos ( - γ + {ψ}_{i} ) + 2 {r}_{i} {sin}^{2} ( \frac{α}{2} ) sin ( {ψ}_{i} ) cos ( α ) cos ( {β}_{i} ) + {r}_{i} {sin}^{2} ( α ) sin ( γ - {ψ}_{i} ) cos ( {β}_{i} ) cos ( γ ) + {r}_{i} sin ( α ) sin ( {β}_{i} ) sin ( γ ) cos ( {θ}_{i} ) - {r}_{i} sin ( {ψ}_{i} ) cos ( α ) cos ( {β}_{i} ) & Formula ( 50 )\end{matrix}$$

Here, mobile robot 104 is assumed to include Nc (Nc≥2) units of telecentric cameras, each of which is a camera that photographs below housing 10. These telecentric cameras detect light emitted to the lower side of housing 10 and reflected on the floor surface. In this case, matrix Fᵢ (where 1≤i≤Nc) represented by the following Equation (51) is defined for each of the plurality of telecentric cameras.

$$[ Mathematical Expression 37 ]$$

$$Formula ( 51 )$$

$${F}_{i} = [ \begin{matrix}{m}_{w 11}^{c} & {m}_{w 12}^{c} & - {m}_{w 11}^{c} {p}_{i , qy} + {m}_{w 12}^{c} {p}_{i , qx} & - {m}_{w 11}^{c} {p}_{i , my} + {m}_{w 12}^{c} {p}_{i , mx} \\ {m}_{w 21}^{c} & {m}_{w 22}^{c} & - {m}_{w 21}^{c} {p}_{i , qy} + {m}_{w 22}^{c} {p}_{i , qx} & - {m}_{w 21}^{c} {p}_{i , my} + {m}_{w 22}^{c} {p}_{i , mx}\end{matrix} ]$$

Furthermore, the velocity of each of the plurality of telecentric cameras is expressed by the following Equation (52).

$$\begin{matrix}[ Mathematial Expression 38 ] & \\ {v}_{i}^{c} = {F}_{i} [ \begin{matrix}{v}_{x} \\ {ν}_{y} \\ ω \\ ω h\end{matrix} ] & Formula ( 52 )\end{matrix}$$

In addition, matrix F and matrix v^{c} are defined as shown in the following Equations (53) and (54).

$$\begin{matrix}[ Mathematical Expression 40 ] & \\ F = [ \begin{matrix}{F}_{1} \\ ⋮ \\ {F}_{{N}_{c}}\end{matrix} ] & Formula ( 53 ) \\ {v}^{c} = [ \begin{matrix}{v}_{1}^{c} \\ ⋮ \\ {v}_{{N}_{c}}^{c}\end{matrix} ] & Formula ( 54 )\end{matrix}$$

From each of the above Equations, the following Equation (55) is derived.

$$\begin{matrix}[ Mathematical Expression 40 ] & \\ [ \begin{matrix} \\ \\ \hat{ω} \\ \hat{ω} \hat{h}\end{matrix} ] = {( {F}^{T} F )}^{- 1} {F}^{T} {v}^{c} & Formula ( 55 )\end{matrix}$$

As described above, in a case where each of first camera 210 and second camera 251 is a telecentric camera, mobile robot 104 can calculate the translational velocity and the angular velocity, i.e., the combined velocity, using the above Equation (55).

As described above, matrix F does not depend on the distance (h) between housing 10 and the floor surface. Matrix F depends on the orientation (α and γ) of housing 10. Although matrix F also depends on the design parameters of mobile robot 104, this is known or can be acquired by the following calibration.

Specifically, mobile robot 104 is disposed on a vertically movable driving body such as a conveyor belt in a predetermined attitude using a jig. Next, a velocity is calculated from the camera (for example, first camera 210) disposed on mobile robot 104 while moving mobile robot 104 up and down at a predetermined velocity and angular velocity. The design parameters (rᵢ, bᵢ, θᵢ, and βᵢ described above) are calculated based on the attitude and the velocity of mobile robot 104 obtained from a plurality of conditions while changing the velocity and the angular velocity. In this way, the design parameters can be acquired.

In addition, in a case where the acceleration of mobile robot 104 is negligible or measured, and in a case where the floor surface is known to be perpendicular to gravity, α and γ can be calculated by the acceleration obtained from acceleration sensor 242.

Furthermore, for example, in a case where mobile robot 104 includes an upward camera (not illustrated) that photographs above mobile robot 104, α and γ can be calculated based on an image (upper image) generated by the upward camera photographing above robot 104.

In any case, when α and γ can be calculated (or acquired), mobile robot 104 can calculate the velocity of mobile robot 104 from Equation (54) described above. Therefore, mobile robot 104 may include a sensor that acquires information for calculating α and γ, such as the IMU and an upward camera.

The accuracy of the velocity calculated by mobile robot 104 depends on the design parameters described above. In order to optimize the accuracy in all the directions viewed from mobile robot 104, it is necessary to make the design parameters of the cameras equal except for a direction of Ψᵢ (Ψᵢ=2πi/Nc [rad]).

More specifically, when θᵢ=0, mobile robot 104 can calculate the velocity of mobile robot 104 with the best accuracy.

Here, it is assumed that the maximum inclination angle of mobile robot 104, more specifically, an angle formed by the floor surface and the bottom surface of housing 10 is 15 deg (15 [deg]=π/12 [rad]). In this case, rᵢ/h and βᵢ depending on the number (Nc) of cameras included in mobile robot 104 can be calculated most accurately in a range of 0≤γ≤2π and 0≤α≤π/12.

In general, when βᵢ is in a range from 36 [deg.] to 39 [deg.] and rᵢ/h is in a range from 1.1 to 1.2, mobile robot 104 can calculate the velocity of mobile robot 104 most accurately.

Note that, in order to calculate the velocity of mobile robot 104, FTF represented by matrix F described above can be remained as an invertible matrix with respect to possible values of α and γ. In other words, a range of values that rᵢ, ψᵢ, θᵢ, and βᵢ can take is not limited to the above.

<Case where Camera is not Telecentric Camera>

The configuration of mobile robot 104 and the method of calculating the velocity of mobile robot 104 are not limited to the above. For example, first camera 210 and second camera 251 may not be telecentric cameras.

For example, it is assumed that mobile robot 104 includes Nc units of cameras, each of which photographs below housing 10. Then, mobile robot 104 calculates v_{i, x} and v_{i, y} based on images obtained from each of Nc units of cameras included in mobile robot 104. According to this configuration, mobile robot 104 can calculate 2Nc velocities based on images obtained from Nc units of cameras.

From these 2Nc velocities, six unknown values can be estimated (calculated) as follows.

First, Gᵢ and G (α, γ, h) are defined as shown in the following Equations (56) and (57).

$$\begin{matrix}[ Mathematical Expression 42 ] & \\ {G}_{i} = {J}_{i} [ \begin{matrix}- 1 & 0 & {p}_{i , y} \\ 0 & - 1 & - {p}_{i , x}\end{matrix} ] & Formula ( 56 ) \\ G ( α , γ , h ) = [ \begin{matrix}{G}_{1} \\ ⋮ \\ {G}_{{N}_{c}}\end{matrix} ] & Formula ( 57 )\end{matrix}$$

Note that, in Equation (57) described above, matrix G is described as G (α, γ, h) to indicate that matrix G depends on α, γ, and h.

Furthermore, G (α, γ, h) can be calculated from a least squares problem shown in the following Equation (58). Specifically, α, γ, h, vₓ, v_{y}, and ω can be calculated from the least squares problem shown in the following Equation (58).

$$\begin{matrix} [ Mathematical Expression 42 ] & \\ \hat{α} , \hat{γ} , \hat{h} , , , \hat{ω} = {arg min }_{α , γ , h , {v}_{x} , {v}_{y} , ω} {‖ {v}_{c} - G ( α , γ , h ) [ \begin{matrix}{v}_{x} \\ {v}_{y} \\ ω\end{matrix} ] ‖}^{2} & Formula ( 58 )\end{matrix}$$

G (α, γ, h) nonlinearly depends on each of α, γ, and h.

In general, the above Equation (58) has a plurality of solutions. Here, a sensor such as an IMU can measure an initial value of each value. As a result, when determining an appropriate solution from a plurality of solutions obtained by the above Equation (58), mobile robot 104 can determine one solution by setting a solution located in the vicinity of the initial value measured by the sensor such as the IMU as an appropriate solution.

According to such a calculation method, calculator 114 can calculate both the translational velocity and the angular velocity based on the images obtained from first camera 210 and second camera 251 by using Equations (56) and (57) described above to calculate the velocity of mobile robot 104. Therefore, in mobile robot 104, since the velocity of mobile robot 104 is calculated, the configuration can be simplified. In addition, since the accuracy of calculation results of α and γ can be improved more than the velocity calculated using the above Equation (55), the accuracy of the calculation result of the velocity of mobile robot 104 can be improved. In addition, according to such a calculation method, since the camera included in mobile robot 104 does not need to be a telecentric camera, the configuration can be further simplified.

The size of an object in the image generated by the telecentric camera does not change regardless of the distance between the object and the telecentric camera. This influence appears in Equations (13) and (14) described above.

As shown in the above Equation (13), J_{i, t} does not depend on h. On the other hand, J_{i, p} depends on the following Mathematical Expression 43 according to the above Equation (28).

tᵢ^{w} [Mathematical Expression 43]

In addition, the following Mathematical Expression 44 depends on h according to the above Equation (5).

tᵢ^{w} [Mathematical Expression 44]

From these, when first camera 210 and second camera 251 are telecentric cameras, they are expressed by a matrix irrelevant to h. Therefore, the translational velocity and the angular velocity of mobile robot 104 can be calculated according to Equation (55) described above.

On the other hand, the above Equation (56) can be used for any type of camera (for example, either the telecentric camera or the pinhole camera may be used.) regardless of the types of first camera 210 and second camera 251.

Still more, G depends on h. Therefore, even when each of first camera 210 and second camera 251 is any type of camera, the attitude (α, γ, h), the translational velocity, and the angular velocity of housing 10 can be calculated according to the above equation (58).

### [Process Procedure]

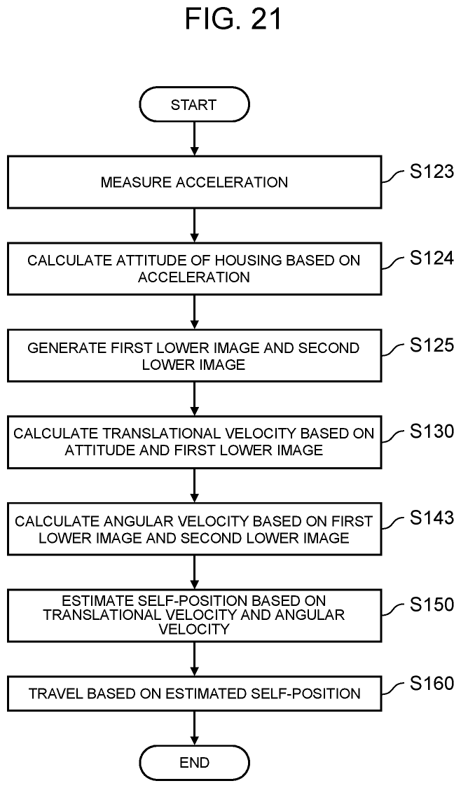

FIG. 21 is a flowchart illustrating a process procedure in mobile robot 104 according to the fifth exemplary embodiment.

First, acceleration sensor 242 measures the acceleration of mobile robot 104 (step S123). Acceleration sensor 242 outputs the measured acceleration to calculator 114.

Next, calculator 114 calculates the attitude of housing 10 based on the acceleration acquired from acceleration sensor 242 (step S124). Specifically, calculator 114 calculates the gravity direction of mobile robot 104 based on the acquired acceleration. Then, calculator 114 calculates inclination with respect to the floor surface from a predetermined attitude of housing 10, i.e., the attitude of housing 10, based on the calculated gravity direction. Information such as the predetermined attitude of housing 10 may be stored in storage unit 150.

Next, first camera 210 and second camera 251 generate images (first lower image and second lower image) by detecting reflected light of light emitted from light source 220 and reflected on the floor surface on which mobile robot 104 travels, during traveling of mobile robot 104. In other words, first camera 210 generates the first lower image, and second camera 251 generates the second lower image (step S125).

Next, calculator 114 calculates the translational velocity of mobile robot 104 based on the attitude of housing 10 and the first lower image (step S130).

Next, calculator 114 calculates the angular velocity of mobile robot 104 based on the first lower image and the second lower image (step S143).

Next, estimator 121 estimates the self-position of mobile robot 104 in the predetermined space based on the translational velocity and the angular velocity (step S150).

Next, controller 130 controls driver 140 to cause mobile robot 104 to travel based on the self-position estimated by estimator 121 (step S160).

### [Effects]

As described above, mobile robot 104 according to the fifth exemplary embodiment includes housing 10, first camera 210, detector 232, calculator 114, estimator 121, controller 130, and second camera 251. Detector 232 includes acceleration sensor 242 configured to measure the acceleration of mobile robot 104. First camera 210 and second camera 251 are attached to housing 10 such that their optical axes are not parallel to each other. Calculator 114 calculates the attitude of housing 10 based on the acceleration of mobile robot 104 measured by acceleration sensor 242. Then, calculator 114 calculates the velocity of mobile robot 104 based on the calculated attitude of housing 10 and the first lower image, and also calculates the angular velocity of mobile robot 104 based on the first lower image and the second lower image. Estimator 121 estimates the self-position based on the angular velocity and the velocity of mobile robot 104.

According to this configuration, since calculator 114 calculates the attitude of housing 10 based on the acceleration acquired from acceleration sensor 242, the attitude can be accurately calculated. Therefore, calculator 114 can calculate the velocity of mobile robot 104 with higher accuracy. As a result, according to mobile robot 104, the self-position can be calculated more accurately.

### Sixth Exemplary Embodiment

Hereinafter, a mobile robot according to a sixth exemplary embodiment will be described. In the description of the sixth exemplary embodiment, differences from mobile robots 100 to 104 according to the first to fifth exemplary embodiments will be mainly described. Configurations substantially similar to those of mobile robots 100 to 104 will be denoted by the same reference marks, and the description thereof may be partially simplified or omitted.

### [Configuration]

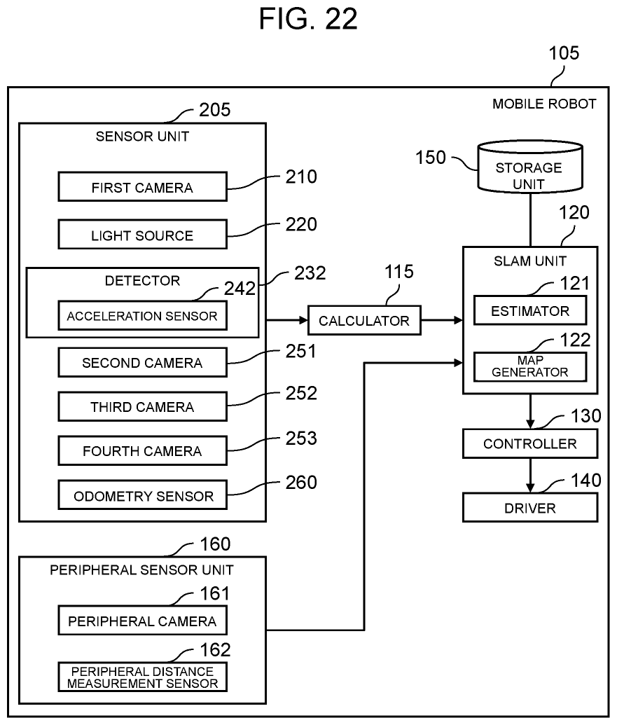

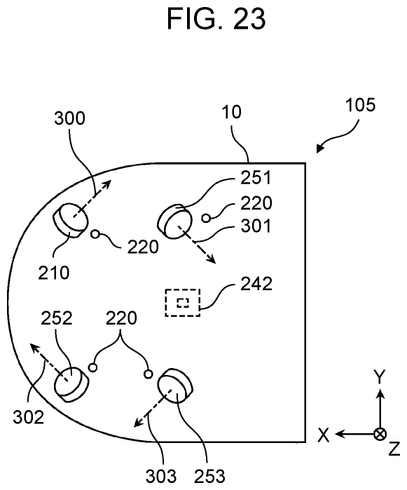

FIG. 22 is a block diagram illustrating a configuration example of mobile robot 105 according to the sixth exemplary embodiment. FIG. 23 is a schematic view illustrating an example of an arrangement layout of each component of sensor unit 205 included in mobile robot 105 according to the sixth exemplary embodiment. Note that FIG. 23 illustrates the arrangement layout of a part of sensor unit 205 as viewed from the bottom surface side of housing 10, and illustration of other components of sensor unit 205, wheel 20, and the like is omitted.

Mobile robot 105 calculates an attitude of housing 10 using an acceleration sensor, and calculates a translational velocity and an angular velocity based on the attitude and a plurality of images generated by different cameras.

Mobile robot 105 includes sensor unit 205, peripheral sensor unit 160, calculator 115, SLAM unit 120, controller 130, driver 140, and storage unit 150.

Sensor unit 205 is a sensor group that detects information for calculating the velocity of mobile robot 105. In the present exemplary embodiment, sensor unit 205 includes first camera 210, light source 220, detector 232, second camera 251, third camera 252, fourth camera 253, and odometry sensor 260.

Each of first camera 210, second camera 251, third camera 252, and fourth camera 253 generates an image (first lower image, second lower image, third lower image, and fourth lower image) by detecting reflected light of light emitted from light source 220 and reflected on a floor surface on which mobile robot 105 travels. In other words, first camera 210 generates the first lower image, second camera 251 generates the second lower image, third camera 252 generates the third lower image, and fourth camera 253 generates the fourth lower image.

As illustrated in FIG. 23, in the present exemplary embodiment, when housing 10 is viewed from the bottom, light source 220 includes a light source such as an LED disposed near each of first camera 210, second camera 251, third camera 252, and fourth camera 253. The vicinity is a range in which each camera can appropriately detect light reflected on the floor surface by each light source 220.

First camera 210, second camera 251, third camera 252, and fourth camera 253 are attached to housing 10 such that their optical axes are not parallel to each other. Specifically, as illustrated in FIG. 23, first camera 210, second camera 251, third camera 252, and fourth camera 253 are attached to housing 10 such that optical axis 300 of first camera 210, optical axis 301 of second camera 251, optical axis 302 of third camera 252, and optical axis 303 of fourth camera 253 are not parallel to each other.

Note that the type of each of first camera 210, second camera 251, third camera 252, and fourth camera 253 is not particularly limited. Each camera may be, for example, a pinhole camera or a telecentric camera.

First camera 210, detector 232, second camera 251, third camera 252, fourth camera 253, and odometry sensor 260 operate in synchronization with each other by a processor such as calculator 115, for example, and periodically and repeatedly output each piece of information at the same time to calculator 115.

Calculator 115 is a processor that calculates the velocity (translational velocity) of mobile robot 105 based on the attitude of housing 10 and the first lower image.

In the present exemplary embodiment, calculator 115 calculates the attitude of mobile robot 105 based on the acceleration (acceleration information) acquired from acceleration sensor 242, similarly to calculator 114 according to the fifth exemplary embodiment.

Calculator 115 calculates the translational velocity of mobile robot 105 based on the calculated attitude of mobile robot 105, the first lower image, the second lower image, the third lower image, and the fourth lower image.

Calculator 115 calculates the angular velocity of mobile robot 105 based on the first lower image, the second lower image, the third lower image, and the fourth lower image.

Calculator 115 calculates the combined velocity of mobile robot 105 from the calculated translational velocity and the calculated angular velocity.

Calculator 115 outputs the calculated combined velocity to SLAM unit 120. Note that calculator 115 may output the calculated translational velocity and the calculated angular velocity to SLAM unit 120 without combining the respective pieces of information.

### [Process Procedure]

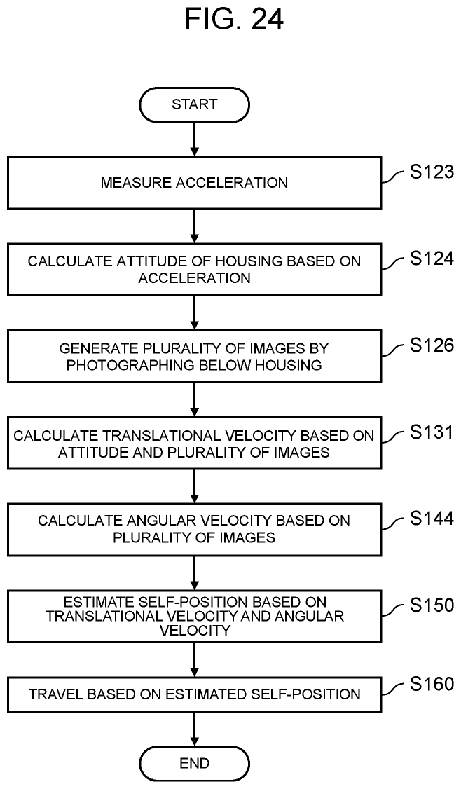

FIG. 24 is a flowchart illustrating a process procedure in mobile robot 105 according to the sixth exemplary embodiment.

First, acceleration sensor 242 measures the acceleration of mobile robot 105 (step S123). Acceleration sensor 242 outputs the measured acceleration to calculator 115.

Next, calculator 115 calculates the attitude of housing 10 based on the acceleration acquired from acceleration sensor 242 (step S124).

Next, each of first camera 210, second camera 251, third camera 252, and fourth camera 253 generates an image (first lower image, second lower image, third lower image, and fourth lower image) by detecting reflected light of light emitted from light source 220 and reflected on the floor surface on which mobile robot 105 travels, during traveling of mobile robot 105. In other words, first camera 210 generates the first lower image, second camera 251 generates the second lower image, third camera 252 generates the third lower image, and fourth camera 253 generates the fourth lower image (step S125). As a result, a plurality of images having different photographing positions are generated at the same time.

Next, calculator 115 calculates the translational velocity of mobile robot 105 based on the attitude of housing 10 and the plurality of images (step S131).

Next, calculator 115 calculates the angular velocity of mobile robot 105 based on the plurality of images (step S144).

Next, estimator 121 estimates the self-position of mobile robot 105 in a predetermined space based on the translational velocity and the angular velocity (step S150).

Next, controller 130 controls driver 140 to cause mobile robot 105 to travel based on the self-position estimated by estimator 121 (step S160).

### [Effects]

As described above, mobile robot 105 according to the sixth exemplary embodiment includes housing 10, first camera 210, light source 220, detector 232, calculator 115, estimator 121, controller 130, second camera 251, third camera 252, and fourth camera 253. Detector 232 further includes acceleration sensor 242 configured to measure the acceleration of mobile robot 105. First camera 210, second camera 251, third camera 252, and fourth camera 253 are attached to housing 10 such that their optical axes are not parallel to each other. Calculator 115 calculates the attitude of housing 10 based on the acceleration of mobile robot 105 measured by acceleration sensor 242. In addition, calculator 115 calculates the translational velocity of mobile robot 105 based on the calculated attitude of housing 10 and the plurality of images (first lower image, second lower image, third lower image, and fourth lower image) obtained from the respective cameras, and calculates the angular velocity of mobile robot 105 based on the plurality of images (first lower image, second lower image, third lower image, and fourth lower image). Estimator 121 estimates the self-position based on the angular velocity and the translational velocity of mobile robot 105.

According to this configuration, since calculator 115 calculates the attitude of housing 10 based on the acceleration acquired from acceleration sensor 242, the attitude can be accurately calculated. Therefore, calculator 115 can calculate the velocity of mobile robot 105 with higher accuracy. Furthermore, calculator 115 calculates the translational velocity and the angular velocity based on the plurality of images obtained from the plurality of cameras. For example, in a case where each camera is a telecentric camera, the number of columns of F^{T} and the number of rows of v_{c} in Equation (55) described above increase as the number of cameras included in mobile robot 105 increases. Therefore, for example, although each row includes an error, when each error is independent, the influence of the error in the combined velocity to be calculated can be reduced as the number of rows is larger. Similarly, in a case where each camera is a pinhole camera, the number of rows of v_{c} and G in Equation (58) described above increases as the number of cameras included in mobile robot 105 increases. Therefore, when the errors generated in the rows of each v_{c} are independent, the larger the number of rows, the smaller the estimation errors of α, γ, h, vₓ, v_{y}, and ω can be. As a result, estimator 121 can calculate the self-position more accurately.

### Seventh Exemplary Embodiment

Hereinafter, a mobile robot according to a seventh exemplary embodiment will be described. In the description of the seventh exemplary embodiment, differences from mobile robots 100 to 105 according to the first to sixth exemplary embodiments will be mainly described. Configurations substantially similar to those of mobile robots 100 to 105 will be denoted by the same reference marks, and the description thereof may be partially simplified or omitted.

### [Configuration]

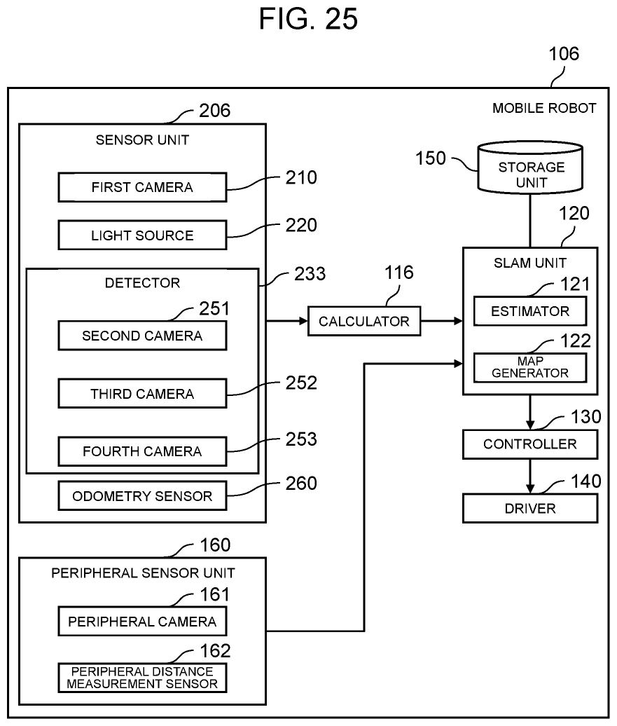

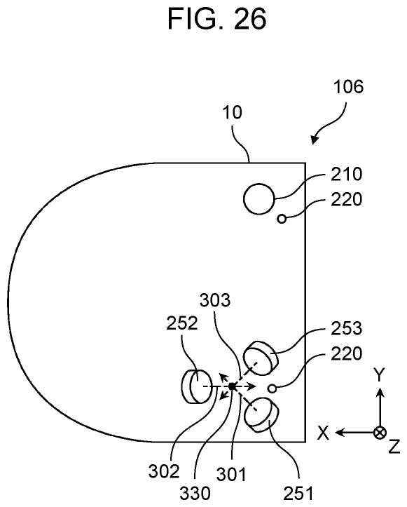

FIG. 25 is a block diagram illustrating a configuration example of mobile robot 106 according to the seventh exemplary embodiment. FIG. 26 is a schematic view illustrating an example of an arrangement layout of each component of sensor unit 206 included in mobile robot 106 according to the seventh exemplary embodiment. Note that FIG. 26 illustrates the arrangement layout of a part of sensor unit 206 as viewed from the bottom surface side of housing 10, and illustration of other components of sensor unit 206, wheel 20, and the like is omitted.

Mobile robot 106 calculates an attitude, a translational velocity, and an angular velocity of housing 10 based on a plurality of images generated by different cameras. In the present exemplary embodiment, the configuration in which mobile robot 106 includes four cameras, which are first camera 210, second camera 251, third camera 252, and fourth camera 253, will be described.

Mobile robot 106 includes sensor unit 206, peripheral sensor unit 160, calculator 116, SLAM unit 120, controller 130, driver 140, and storage unit 150.

Sensor unit 206 is a sensor group that detects information for calculating the velocity of mobile robot 106. In the present exemplary embodiment, sensor unit 206 includes first camera 210, light source 220, detector 233, and odometry sensor 260.

Detector 233 includes second camera 251, third camera 252, and fourth camera 253.

Each of first camera 210, second camera 251, third camera 252, and fourth camera 253 generates an image (first lower image, second lower image, third lower image, and fourth lower image) by detecting reflected light of light emitted from light source 220 and reflected on a floor surface on which mobile robot 106 travels. In other words, first camera 210 generates the first lower image, second camera 251 generates the second lower image, third camera 252 generates the third lower image, and fourth camera 253 generates the fourth lower image.

As illustrated in FIG. 26, in the present exemplary embodiment, light source 220 is a light source such as an LED disposed in the vicinity of each of first camera 210, second camera 251, third camera 252, and fourth camera 253 when housing 10 is viewed from the bottom. In the present exemplary embodiment, light source 220 includes one light source disposed with respect to first camera 210, and one light source disposed with respect to second camera 251, third camera 252, and fourth camera 253. The vicinity is a range in which each camera can appropriately detect light reflected on the floor surface by each light source 220.

In addition, three cameras among first camera 210, second camera 251, third camera 252, and fourth camera 253 are attached to housing 10 such that their respective optical axes pass through predetermined position 330. In the present exemplary embodiment, second camera 251, third camera 252, and fourth camera 253 are attached to housing 10 such that their optical axes, which are optical axis 301 of second camera 251, optical axis 302 of third camera 252, and optical axis 303 of fourth camera 253, are not parallel to each other. Specifically, second camera 251, third camera 252, and fourth camera 253 are attached to housing 10 such that respective optical axes, which are optical axes 301, 302, and 303, pass through predetermined position 330. More specifically, as illustrated in FIG. 26, second camera 251, third camera 252, and fourth camera 253 are attached to housing 10 such that optical axis 301 of second camera 251, optical axis 302 of third camera 252, and optical axis 303 of fourth camera 253 pass through predetermined position 330 indicated by a black dot in FIG. 26. The predetermined position is not particularly limited, and can be arbitrarily determined.

On the other hand, one of first camera 210, second camera 251, third camera 252, and fourth camera 253 except for the above-described three cameras is attached to housing 10 such that its optical axis does not pass through predetermined position 330. In the present exemplary embodiment, first camera 210 is attached to housing 10 such that the optical axis of first camera 210 does not pass through predetermined position 330.

Note that each of first camera 210, second camera 251, third camera 252, and fourth camera 253 is, for example, a telecentric camera.

First camera 210, detector 233 (i.e., second camera 251, third camera 252, and fourth camera 253), and odometry sensor 260 operate in synchronization with each other by a processor such as calculator 116, for example, and periodically and repeatedly output each piece of information at the same time to calculator 116.

Calculator 116 is a processor that calculates the velocity (translational velocity) of mobile robot 106 based on the attitude of housing 10 and the first lower image.

In the present exemplary embodiment, calculator 116 calculates the attitude of mobile robot 106 based on the second lower image photographed by second camera 251, the third lower image photographed by third camera 252, and the fourth lower image photographed by fourth camera 253.

Calculator 116 calculates the translational velocity of mobile robot 106 based on the calculated attitude of mobile robot 106 (more specifically, the attitude of housing 10) and the first lower image, the second lower image, the third lower image, and the fourth lower image.

Calculator 116 calculates the angular velocity of mobile robot 106 based on the first lower image, the second lower image, the third lower image, and the fourth lower image.

Calculator 116 calculates the combined velocity of mobile robot 106 from the calculated translational velocity and the calculated angular velocity.

Calculator 116 outputs the calculated combined velocity to SLAM unit 120. Note that calculator 116 may output the calculated translational velocity and the calculated angular velocity to SLAM unit 120 without combining the respective pieces of information.

### [Velocity Calculation Process]

Next, a specific calculation method of the combined velocity of mobile robot 106 will be described.

Mobile robot 106 includes at least four cameras, and more particularly four telecentric cameras.

In addition, at least three cameras included in mobile robot 106 are configured such that the optical axes pass through the same point. In the present exemplary embodiment, second camera 251, third camera 252, and fourth camera 253 are attached to housing 10 such that their respective optical axes pass through predetermined position 330.

On the other hand, at least one camera included in mobile robot 106 is configured such that the optical axis does not pass through the above-described “same point”. In the present exemplary embodiment, first camera 210 is attached to housing 10 such that its optical axis does not pass through predetermined position 330.

Assuming that each camera included in mobile robot 106 is a telecentric camera, the following Equations (59) to (66) are defined.

$$\begin{matrix}[ Mathematical Expression 45 ] & \\ {m}_{rx}^{w} = [ \begin{matrix}- 2 {sin}^{2} ( \frac{α}{2} ) {sin}^{2} ( γ ) + 1 \\ 2 {sin}^{2} ( \frac{α}{2} ) sin ( γ ) cos ( γ ) \\ sin ( α ) sin ( y )\end{matrix} ] & Formula ( 59 ) \\ {m}_{ry}^{w} = [ \begin{matrix}2 {sin}^{2} ( \frac{α}{2} ) sin ( γ ) cos ( γ ) \\ - 2 {sin}^{2} ( \frac{α}{2} ) {cos}^{2} ( γ ) + 1 \\ - sin ( α ) cos ( y )\end{matrix} ] & Formula ( 60 ) \\ {m}_{rz}^{w} = [ \begin{matrix}- sin ( α ) sin ( γ ) \\ sin ( α ) cos ( γ ) \\ cos ( α )\end{matrix} ] & Formula ( 61 ) \\ {m}_{cx , i}^{r} = [ \begin{matrix}- 2 {sin}^{2} ( \frac{{β}_{i}}{2} ) {sin}^{2} ( {ψ}_{i} + {θ}_{i} ) + 1 \\ 2 {sin}^{2} ( \frac{{β}_{i}}{2} ) sin ( {ψ}_{i} + {θ}_{i} ) cos ( {ψ}_{i} + {θ}_{i} ) \\ - sin ( {β}_{i} ) sin ( {ψ}_{i} + {θ}_{i} )\end{matrix} ] & Formula ( 62 ) \\ {m}_{cy , i}^{r} = [ \begin{matrix}2 {sin}^{2} ( \frac{{β}_{i}}{2} ) sin ( {ψ}_{i} + {θ}_{i} ) cos ( {ψ}_{i} + {θ}_{i} ) \\ - 2 {sin}^{2} ( \frac{{β}_{i}}{2} ) {cos}^{2} ( {ψ}_{i} + {θ}_{i} ) + 1 \\ sin ( {β}_{i} ) cos ( {ψ}_{i} + {θ}_{i} )\end{matrix} ] & Formula ( 63 ) \\ {m}_{cz , i}^{r} = [ \begin{matrix} sin ( {β}_{i} ) sin ( {ψ}_{i} + {θ}_{i} ) \\ - sin ( {β}_{i} ) cos ( {ψ}_{i} + {θ}_{i} ) \\ cos ( {β}_{i} )\end{matrix} ] & Formula ( 64 ) \\ {m}_{ct , i}^{r} = [ \begin{matrix}{r}_{i} cos ( {ψ}_{i} ) \\ {r}_{i} sin ( {ψ}_{i} ) \\ {b}_{i}\end{matrix} ] & Formula ( 65 ) \\ [ Mathematical Expression 47 ] & \\ {K}_{i} = \frac{{m}_{cz , i}^{r} {m}_{rz}^{{w}^{T}}}{{m}_{rz}^{{w}^{T}} {m}_{cz , i}^{r}} - I & Formula ( 66 )\end{matrix}$$

Note that I in Equation (66) is an identity matrix represented by the following Equation (67).

$$\begin{matrix}[ Mathematical Expression 48 ] & \\ I = [ \begin{matrix}1 & 0 & 0 \\ 0 & 1 & 0 \\ 0 & 0 & 1\end{matrix} ] & Formula ( 67 )\end{matrix}$$

From the above Equations (59) to (67), matrix Fᵢ in the above Equation (51) is expressed by the following Equation (68).

$$\begin{matrix}[ Mathematical Expression 49 ] & \\ {F}_{i} = [ \begin{matrix}{m}_{c x , {i}^{T}}^{r} \\ {m}_{cy , {i}^{T}}^{r}\end{matrix} ] [ \begin{matrix}{m}_{r x}^{w} & {m}_{r y}^{w} & {K}_{i} {m}_{c t , i}^{r} \times {m}_{r z}^{w} & \frac{{m}_{rz}^{w} \times {m}_{cz , i}^{r}}{{m}_{rz}^{{w}^{T}} {m}_{cz , i}^{r}}\end{matrix} ] & Formula ( 68 )\end{matrix}$$

Note that “x” in Equation (68) represents an outer product.

Next, the following Equations (69) and (70) are defined.

$$\begin{matrix}[ Mathematical Expression 50 ] & \\ {C}_{i} = [ \begin{matrix}{m}_{cx , i}^{r} & {m}_{cy , i}^{r} & {m}_{cz , i}^{r}\end{matrix} ] & Formula ( 69 ) \\ {q}_{i} = {C}_{i} [ \begin{matrix}{v}_{i}^{c} \\ 0\end{matrix} ] & Formula ( 70 )\end{matrix}$$

Here, assuming that predetermined position 330 in the reference frame in mobile robot 106 is point p^{o}, velocity (translational velocity) v^{o} and distance (height) h^{o} at point p^{o} are expressed by the following Equations (71) and (72).

[Mathematical Expression 51]

v^{o}=mᵣₓ^{w}vₓ+m_{ry}^{w}v_{y}+ωmᵣₓ^{w}×p^{o} Formula (71)=

h^{o}=h+m_{rz}^{w}^{^{T}}p⁰ Formula (72)

Next, the following Equation (73) is calculated from Equations (52), (68), (71), and (72) described above.

$$\begin{matrix}[ Mathematical Expression 52 ] & \\ {q}_{i} = {P}_{i} \{ {v}^{o} + {K}_{i} ( {m}_{ct , i}^{r} - {p}^{o} ) \times {m}_{rz}^{w} ω \} + \frac{{m}_{rz}^{w} \times {m}_{cz , i}^{r}}{{m}_{rz}^{{w}^{T}} {m}_{cz , i}^{r}} ω {h}^{o} & Formula ( 73 )\end{matrix}$$

Note that Pᵢ in the above Equation (73) is defined by the following Equation (74).

[Mathematical Expression 53]

Pᵢ=I−m_{cz,i}^{r}m_{cz,i}^{r}^{^{T}} Formula (74)

Here, it is assumed that point p^{o} is located on the optical axis of the camera included in mobile robot 106. In this case, the following Equation (75) is calculated from the above Equation (73).

$$\begin{matrix}[ Mathematical Expression 54 ] & \\ {q}_{i} = {P}_{i} {v}^{o} + \frac{{m}_{rz}^{w} \times {m}_{cz , i}^{r}}{{m}_{rz}^{{w}^{T}} {m}_{cz , i}^{r}} {ω h}^{o} & Formula ( 75 )\end{matrix}$$

It is also assumed that the optical axes of at least three cameras included in mobile robot 106 pass through point p^{o}. In order not to impair the generality, indexes of three cameras whose optical axes pass through the point p^{o} are set to 1, 2, and 3.

In addition, the following Equations (76) and (77) are defined.

[Mathematical Expression 55]

uᵢ=m_{cz,i}^{r}^{^{T}}m_{rz}^{w} Formula (76)

eᵢⱼ=m_{cz,i}^{r}×m_{cz,j}^{r} Formula (77)

Then, the following Equations (78) and (79) are defined.

$$\begin{matrix}[ Mathematical Expression 56 ] & \\ {S}^{a} = [ \begin{matrix}{s}_{1}^{a} \\ {s}_{2}^{a} \\ {s}_{3}^{a}\end{matrix} ] = [ \begin{matrix}{e}_{12}^{T} & - {e}_{12}^{T} & 0 \\ {e}_{31}^{T} & 0 & - {e}_{31}^{T} \\ 0 & {e}_{23}^{T} & - {e}_{23}^{T}\end{matrix} ] [ \begin{matrix}{q}_{1} \\ {q}_{2} \\ {q}_{3}\end{matrix} ] & Formula ( 78 ) \\ {s}^{b} = [ \begin{matrix}{s}_{1}^{b} \\ {s}_{2}^{b} \\ {s}_{3}^{b}\end{matrix} ] = [ \begin{matrix}{e}_{12}^{T} & {e}_{12}^{T} & 0 \\ {e}_{31}^{T} & 0 & {e}_{31}^{T} \\ 0 & {e}_{23}^{T} & {e}_{23}^{T}\end{matrix} ] [ \begin{matrix}{q}_{1} \\ {q}_{2} \\ {q}_{3}\end{matrix} ] & Formula ( 79 )\end{matrix}$$

By using the characteristic of the outer product, i.e., outer product calculation, the following Equations (80) and (81) are defined.

$$\begin{matrix}[ Mathematical Expression 57 ] & \\ {s}^{a} = ω {h}^{o} [ \begin{matrix}\frac{{u}_{2}}{{u}_{1}} + \frac{{u}_{1}}{{u}_{2}} - 2 {e}_{1}^{T} {e}_{2} \\ \frac{{u}_{1}}{{u}_{3}} + \frac{{u}_{3}}{{u}_{1}} - 2 {e}_{3}^{T} {e}_{1} \\ \frac{{u}_{3}}{{u}_{2}} + \frac{{u}_{2}}{{u}_{3}} - 2 {e}_{2}^{T} {e}_{3}\end{matrix} ] & Formula ( 80 ) \\ {s}^{b} = [ \begin{matrix}ω {h}^{o} ( \frac{{u}_{2}}{{u}_{1}} - \frac{{u}_{1}}{{u}_{2}} ) + 2 {e}_{12}^{T} {v}^{o} \\ ω {h}^{o} ( \frac{{u}_{1}}{{u}_{3}} - \frac{{u}_{3}}{{u}_{2}} ) + 2 {e}_{31}^{T} {v}^{o} \\ ω {h}^{o} ( \frac{{u}_{3}}{{u}_{2}} - \frac{{u}_{2}}{{u}_{3}} ) + 2 {e}_{23}^{T} {v}^{o}\end{matrix} ] & Formula ( 81 )\end{matrix}$$

Further, the following Equations (82) and (83) are defined.

$$\begin{matrix}[ Mathematical Expression 58 ] & \\ μ = [ \begin{matrix}\frac{{u}_{2}}{{u}_{1}} - \frac{{u}_{1}}{{u}_{2}} \\ \frac{{u}_{1}}{{u}_{3}} - \frac{{u}_{3}}{{u}_{1}} \\ \frac{{u}_{3}}{{u}_{2}} - \frac{{u}_{2}}{{u}_{3}}\end{matrix} ] & Formula ( 82 ) \\ {E}_{x} = [ \begin{matrix}{e}_{12}^{T} \\ {e}_{31}^{T} \\ {e}_{23}^{T}\end{matrix} ] & Formula ( 83 )\end{matrix}$$

Next, the following Equation (84) is calculated from the above Equation (81).

$$\begin{matrix}[ Mathematical Expression 59 ] & \\ {v}^{o} = \frac{{E}_{x}^{- 1} ( {s}^{b} - ω {h}^{o} μ )}{2} & Formula ( 84 )\end{matrix}$$

Here, the following Equations (85) and (86) are defined as ω≠0 and h^{o}≠0.

$$\begin{matrix}[ Mathematical Expression 60 ] & \\ {ρ}_{1} = \frac{{s}_{1}^{a}}{‖ s ‖} & Formula ( 85 ) \\ {ρ}_{2} = \frac{{s}_{2}^{a}}{‖ s ‖} & Formula ( 86 )\end{matrix}$$

Values of ρ₁ and ρ₂ depend only on the design parameters (ψᵢ, βᵢ, and θᵢ) and the unknown values α and γ. On the other hand, it is found that the values of ρ₁ and ρ₂ are independent from unknown values h, vₓ, v_{y}, and ω from the above Equations (61), (64), (76), and (77).

Each value of ρ₁ and ρ₂ corresponds to two sets: (α, γ) and (α′, γ′). Specifically, (ρ₁, ρ₂) depends only on unknown values α and γ. Here, (ρ₁, ρ₂) and α and γ are not in a one-to-one relationship. Although many solutions to (ρ₁, ρ₂) are calculated, (α, γ)≠(α′, γ′) is calculated by the same (ρ₁, ρ₂). In other words, when the value of (ρ₁, ρ₂) is known, (α, γ) can be narrowed down to two solutions from a large number of solutions. One of the two solutions is a value calculated from a correct value (i.e., the orientation of the entity of mobile robot 106), and the other is an incorrect value (i.e., not suitable for the entity of mobile robot 106).

Hereinafter, an amount calculated from (α, γ) is defined as X, and an amount calculated from (α′, γ′) is defined as x′.

Since these two solutions satisfy u₁u₁′=u₂u₂′=u₃u₃′, the following

Equations (87), (88), and (89) are calculated.

[Mathematical Expression 61]

μ′=−μ Formula (87)

ω′h^{o}′=ωh^{o} Formula (88)

v′−v=ωh^{o}Eₓ⁻¹μ Formula (89)

Next, a calculation method for calculating the translational velocity (vₓ and v_{y}) and the angular velocity (ω) of mobile robot 106 will be described.

From the following measured values of Mathematical Expression 62, qᵢ (1≤i≤3) is calculated using Equation (70).

vᵢ^{c} [Mathematical Expression 62]

Further, s is calculated from Equation (78).

Here, it is assumed that the following Mathematical Expression 63 is satisfied.

∥s^{α}∥=0 [Mathematical Expression 63]

Then, each value of the following Mathematical Expression 64 needs to be calculated using a sensor such as an accelerometer.

\hat{α} and \hat{γ} [Mathematical Expression 64]

On the other hand, assuming that the inclination of mobile robot 106 (more specifically, the inclination of housing 10) does not change much in a short time, the current value can be calculated as an approximate value using the last calculated value.

In addition, it is assumed that the following Mathematical Expression 65 is satisfied.

∥s^{α}∥≠0 [Mathematical Expression 65]

Then, (ρ₁, ρ₂) can be calculated using the above Equations (85) and (86). In addition, from the calculated (ρ₁, ρ₂), two solutions represented in Mathematical Expression 66 can be calculated using the above Equation (80) or a lookup table. Note that the lookup table is stored in storage unit 150 in advance, for example.

(\hat{α} [symbol] \hat{γ}) and (\hat{α}′ [symbol] \hat{γ}′) [Mathematical Expression 66]

The following Mathematical Expression 67 can be calculated by calculating the two solutions, i.e., the two solutions becoming known.

[symbol]

[Mathematical Expression 67]

Furthermore, the following Mathematical Expression 68 can be calculated.

[symbol]

(1≤i≤3) and \hat{μ} [Mathematical Expression 68]

Next, the following Equation (90) is defined from the above Equation (80).

$$\begin{matrix}[ Mathematical Expression 69 ] & \\ {d}^{a} = [ \begin{matrix}\frac{}{} + \frac{}{} - 2 {e}_{1}^{T} {e}_{2} \\ \frac{}{} + \frac{}{} - 2 {e}_{3}^{T} {e}_{1} \\ \frac{}{} + \frac{}{} - 2 {e}_{2}^{T} {e}_{3}\end{matrix} ] & Formula ( 90 )\end{matrix}$$

In addition, ωh^{o} can be calculated (estimated) as shown in the following Equation (91).

[Mathematical Expression 70]

[symbol]

=(d^{α}^{^{T}}d^{α})⁻¹d^{α}^{^{T}}s^{α} Formula (91)

Next, two velocities in the following Mathematical Expression 71 are calculated using Equation (84).

[symbol]

and [symbol] [Mathematical Expression 71]

Here, it is apparent from Equation (71) that v^{o} is orthogonal to the following Mathematical Expression 72.

m_{rz}^{w} [Mathematical Expression 72]

From this, in general, a correct solution can be determined by excluding one of the two solutions described above.

However, when v^{o} is proportional to the following Mathematical Expression 73, in other words, v^{o} is orthogonal to both in the following Mathematical Expression 74, it cannot be determined which of the two solutions described above is correct.

m_{rz}^{w}×m_{rz}^{w}′ [Mathematical Expression 73]

m_{rz}^{w} and m_{rz}^{w}′ [Mathematical Expression 74]

In practice, due to a measurement error, the following Equation 75 is not completely 0.

[symbol]

[symbol]

[Mathematical Expression 75]

Therefore, the following Mathematical Expression 76 can be considered orthogonal when Mathematical Expression 77 is satisfied.

[symbol]

and [symbol] [Mathematical Expression 76]

[symbol]

[symbol]

<θ^{⊥}(θ^{⊥}:Arbitrary threshold) [Mathematical Expression 77]

Here, it is assumed that the optical axes of camera N^{o}+1 to camera N^{e} do not pass through point p^{o}.

In this case, the following Equations (92) to (98) are defined from the above Equation (73).

$$\begin{matrix}[ Mathematical Expression 78 ] & \\ {d}_{i}^{h} = \frac{\times }{ {m}_{cz , i}^{r}} & Formula ( 92 ) \\ {d}_{i}^{ω} = {P}_{i} \{ {\hat{K}}_{i} ( {m}_{ct , i}^{r} - {p}^{o} ) \times \} & Formula ( 93 ) \\ {d}^{h} = [ \begin{matrix}{d}_{{N}^{o} + 1}^{h} \\ ⋮ \\ {d}_{{N}^{c}}^{h}\end{matrix} ] & Formula ( 94 ) \\ [ Mathematical Expression 79 ] & \\ P = [ \begin{matrix}{P}_{{N}^{o} + 1} \\ ⋮ \\ {P}_{{N}^{c}}\end{matrix} ] & Formula ( 95 ) \\ {d}^{q} = [ \begin{matrix}{q}_{{N}^{o} + 1} \\ ⋮ \\ {q}_{{N}^{c}}\end{matrix} ] & Formula ( 96 ) \\ {d}^{ω} = [ \begin{matrix}{d}_{{N}^{o} + 1}^{ω} \\ ⋮ \\ {d}_{{N}^{c}}^{ω}\end{matrix} ] & Formula ( 97 ) \\ {d}^{a} = {d}^{q} - - {d}^{h} & Formula ( 98 )\end{matrix}$$

Next, ω can be calculated from the following Equation (99).

[Mathematical Expression 80]

\hat{ω}=(d^{ω}^{^{T}}d^{ω})⁻¹d^{ω}^{^{T}}d^{α} Formula (99)

Next, an estimated value of h^{o} can be easily calculated from the following Equation (100).

$$\begin{matrix}[ Mathematical Expression 81 ] & \\ = \frac{\hat{ω}}{} & Formula ( 100 )\end{matrix}$$

Theoretically, the following Mathematical Expression 82 is 0 when the following Mathematical Expression 83 is the solution, and is not 0 when the following Mathematical Expression 84 is not the solution.

∥d^{α}−d^{ω}ω∥ [Mathematical Expression 82]

(\hat{α} [symbol] \hat{γ}) [Mathematical Expression 83]

(\hat{α} [symbol] \hat{γ}) [Mathematical Expression 84]

This result can be used to determine which of the two solutions described above is the correct solution.

Note that, also here, the value does not accurately become 0 due to a measurement error, and the above-described threshold can be used.

In addition, both values of the above two solutions may become 0.

This occurs when the following Equation (101) is satisfied.

$$\begin{matrix}[ Mathematical Expression 85 ] & \\ P {E}_{x}^{- 1} μ + {d}^{{h}^{′}} - {d}^{h} = [ {d}^{w} - {d}^{{w}^{′}} ] [ \begin{matrix}\frac{1}{{h}^{o}} \\ \frac{1}{{h}^{{o}^{′}}}\end{matrix} ] & Formula ( 101 )\end{matrix}$$

Note that in a case where velocity v^{o} is proportional to the following Mathematical Expression 87, the following Mathematical Expression 86 can be calculated by appropriately selecting the configuration, arrangement layout, and the like of the cameras included in mobile robot 106 so as not to satisfy Equation (101) described above.

(\hat{α} [symbol] \hat{γ} [symbol] h) [Mathematical Expression 86]

m_{rz}^{w}×m_{rz}^{w}′ [Mathematical Expression 87]

In this way, the correct solution can be appropriately selected from the two solutions described above.

Note that mobile robot 106 may include a sensor such as the acceleration sensor. In this case, mobile robot 106 may determine which of the two solutions is closer to the value obtained from the sensor, and determine the solution having the closer value as the correct solution.

It is assumed that the inclination of mobile robot 106 (more specifically, the inclination of housing 10) does not change much in a short time as described above, and a solution closest to the last calculated value may be selected as the correct solution.

Finally, vₓ, v_{y}, and h are calculated (estimated) using the above Equations (71) and (72) according to Equations (102) and (103) shown below.

$$\begin{matrix}[ Mathematical Expression 88 ] & \\ [ \begin{matrix}{v}_{x} \\ {v}_{y}\end{matrix} ] = [ \begin{matrix}{m}_{rx}^{{w}^{T}} \\ {m}_{ry}^{{w}^{T}}\end{matrix} ] ( - \hat{ω} \times {p}^{o} ) & Formula ( 102 ) \\ \hat{h} = - {p}^{o} & Formula ( 103 )\end{matrix}$$

According to mobile robot 106, for example, the velocity (combined velocity) can be accurately calculated without using other sensors, such as the IMU, in addition to the camera except for some cases such as ω=0. Furthermore, according to the above calculation method, since the calculated value is completely independent from other sensors such as odometry sensor 260, it is considered that an error in the value (estimated value) calculated from the image generated by the camera is completely independent from the error in the value such as the travel distance obtained from odometry sensor 260 or the like. Therefore, by combining these two values, an error in the self-position finally calculated is expected to be lower than an error in the self-position calculated from each of these two values.

### [Process Procedure]

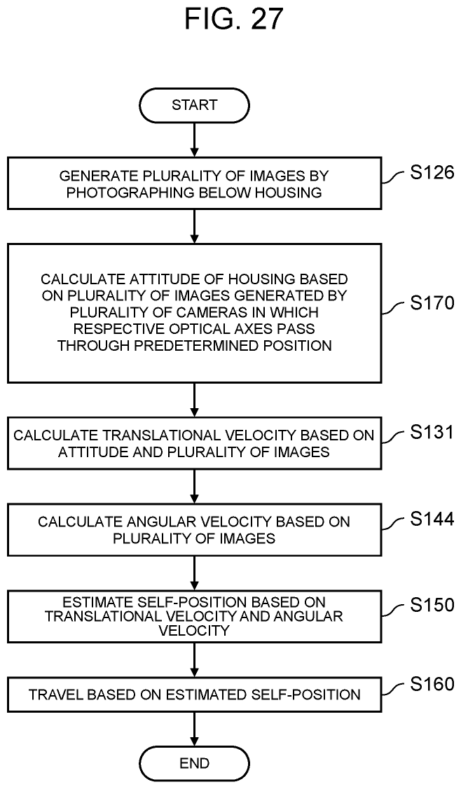

FIG. 27 is a flowchart illustrating a process procedure in mobile robot 106 according to the seventh exemplary embodiment.

First, each of first camera 210, second camera 251, third camera 252, and fourth camera 253 generates an image (first lower image, second lower image, third lower image, and fourth lower image) by detecting reflected light of light emitted from light source 220 and reflected on the floor surface on which mobile robot 105 travels, while mobile robot 105 is traveling. In other words, first camera 210 generates the first lower image, second camera 251 generates the second lower image, third camera 252 generates the third lower image, and fourth camera 253 generates the fourth lower image (step S126). As a result, a plurality of images having different photographing positions are generated at the same time.

Next, calculator 116 calculates the attitude of housing 10 based on the plurality of images generated by the plurality of cameras whose optical axes pass through predetermined position 330 (step S170). Specifically, calculator 116 calculates the attitude of housing 10 based on the first lower image, the second lower image, the third lower image, and the fourth lower image.

Next, calculator 116 calculates the translational velocity of mobile robot 106 based on the attitude of housing 10 and the plurality of images (step S131).

Next, calculator 116 calculates the angular velocity of mobile robot 106 based on the plurality of images (step S144).

Next, estimator 121 estimates the self-position of mobile robot 106 in the predetermined space based on the translational velocity and the angular velocity (step S150).

Next, controller 130 controls driver 140 to cause mobile robot 106 to travel based on the self-position estimated by estimator 121 (step S160).

### [Effects]

As described above, mobile robot 106 according to the seventh exemplary embodiment includes housing 10, first camera 210, light source 220, detector 233, calculator 116, estimator 121, and controller 130. Detector 233 includes second camera 251, third camera 252, and fourth camera 253. Specifically, detector 233 includes second camera 251 attached to housing 10 and configured to generate the second lower image by photographing below housing 10, third camera 252 attached to housing 10 and configured to generate the third lower image by photographing below housing 10, and fourth camera 253 attached to housing 10 and configured to generate the fourth lower image by photographing below housing 10.

Three of first camera 210, second camera 251, third camera 252, and fourth camera 253 are attached to housing 10 such that their respective optical axes pass through predetermined position 330. In the present exemplary embodiment, second camera 251, third camera 252, and fourth camera 253 are attached to housing 10 such that the respective optical axes, i.e., optical axis 301 of second camera 251, optical axis 302 of third camera 252, and optical axis 303 of fourth camera 253 pass through predetermined position 330. On the other hand, one of first camera 210, second camera 251, third camera 252, and fourth camera 253, excluding the above-described three cameras, is attached to housing 10 such that its optical axis does not pass through predetermined position 330. In the present exemplary embodiment, first camera 210 is attached to housing 10 such that the optical axis of first camera 210 does not pass through predetermined position 330. Calculator 116 calculates the angular velocity of mobile robot 106 and the attitude of housing 10 based on the first lower image by first camera 210, the second lower image by second camera 251, the third lower image by third camera 252, and the fourth lower image by fourth camera 253.

Estimator 121 estimates the self-position of mobile robot 106 based on the angular velocity and the velocity of mobile robot 106.

According to this configuration, since calculator 116 calculates the attitude of housing 10 based on the images acquired from the plurality of cameras, it is possible to accurately calculate the attitude. Furthermore, since mobile robot 106 does not include a sensor such as the IMU, mobile robot 106 is realized with a simple configuration.

### Other Embodiments

Although the mobile robot according to the present disclosure has been described above based on the above exemplary embodiments, the present disclosure is not limited to the above exemplary embodiments.

For example, the unit of numerical values representing a distance such as b and h is not particularly limited as long as the same unit is adopted for each.

In addition, for example, in the above-described exemplary embodiments, the processor such as the calculator included in the mobile robot has been described as being realized by the CPU and the control program, respectively. For example, each of the components of the processor may include one or a plurality of electronic circuits. Each of the one or more electronic circuits may be a general-purpose circuit or a dedicated circuit. The one or more electronic circuits may include, for example, a semiconductor device, an integrated circuit (IC), a large scale integration (LSI), or the like. The IC or the LSI may be integrated on one chip or may be integrated on a plurality of chips. Although referred to as the IC or the LSI here, the terms vary depending on a degree of integration, and may be referred to as a system LSI, a very large scale integration (VLSI), or an ultra large scale integration (ULSI). A Field Programmable Gate Array (FPGA) programmed after the manufacture of the LSI can also be used for the same purpose.

Still more, the process procedure executed by each processor described above is merely an example, and is not particularly limited. For example, the calculator may not calculate the combined velocity, and the estimator may calculate the combined velocity. In addition, the processor that calculates the translational velocity and the processor that calculates the angular velocity may be realized by different CPUs or dedicated electronic circuits.

Still more, for example, the calculator may correct the calculated attitude, the translational velocity, and the angular velocity based on information obtained from the odometry sensor. Alternatively, for example, the calculator may calculate the attitude, the translational velocity, and the angular velocity of the mobile robot based on the image obtained from the camera and the information obtained from the odometry sensor.

Still more, the components in each exemplary embodiment may be arbitrarily combined.

Still more, general or specific aspects of the present disclosure may be implemented by a system, an apparatus, a method, an integrated circuit, or a computer program. Alternatively, the present disclosure may be realized by a computer-readable non-transitory recording medium such as an optical disk, a hard disk drive (HDD), or a semiconductor memory in which the computer program is stored. In addition, the present disclosure may be realized by an arbitrary combination of a system, an apparatus, a method, an integrated circuit, a computer program, and a recording medium.

Furthermore, the present disclosure includes a mode obtained by applying various modifications conceived by those skilled in the art to each exemplary embodiment, and a mode realized by arbitrarily combining components and functions in each exemplary embodiment without departing from the gist of the present disclosure.

The present disclosure is applicable to autonomous vacuum cleaners that clean while moving autonomously.

What is claimed is:

1. A mobile robot that autonomously travels in a predetermined space, the mobile robot comprising:
a housing;
a first camera attached to the housing and configured to generate a first lower image by photographing below the housing;
a detector attached to the housing and configured to detect an attitude of the housing;
a calculator configured to calculate a velocity of the mobile robot based on the attitude and the first lower image;
an estimator configured to estimate a self-position of the mobile robot in the predetermined space based on the velocity; and
a controller configured to control the mobile robot to travel based on the self-position.

2. The mobile robot according to claim 1, wherein
the detector includes three or more distance measurement sensors, each of the three or more distance measurement sensors measuring a distance between a floor surface on which the mobile robot travels and the housing, and
the calculator calculates the attitude based on the distance obtained from each of the three or more distance measurement sensors.

3. The mobile robot according to claim 1, wherein
the detector includes a light source that emits structured light toward below the mobile robot,
the first camera generates the first lower image by detecting reflected light of the structured light emitted from the light source and reflected on a floor surface on which the mobile robot travels, and
the calculator calculates the attitude and the velocity based on the first lower image.

4. The mobile robot according to claim 1, further comprising:
an angular velocity sensor attached to the housing and configured to measure an angular velocity of the mobile robot, wherein
the estimator estimates the self-position based on the angular velocity and the velocity.

5. The mobile robot according to claim 1, further comprising:
a second camera attached to the housing and configured to generate a second lower image by photographing below the housing, wherein
the calculator calculates an angular velocity of the mobile robot based on the first lower image and the second lower image, and
the estimator estimates the self-position based on the angular velocity and the velocity.

6. The mobile robot according to claim 1, further comprising:
a second camera attached to the housing and configured to generate a second lower image by photographing below the housing, wherein
the detector includes an acceleration sensor that measures acceleration of the mobile robot,
the first camera and the second camera are attached to the housing, optical axes of the first camera and the second camera being not parallel to each other,
the calculator calculates the attitude based on the acceleration, the velocity based on the attitude calculated and the first lower image, and an angular velocity of the mobile robot based on the first lower image and the second lower image, and
the estimator estimates the self-position based on the angular velocity and the velocity.

7. The mobile robot according to claim 1, wherein
the detector includes a second camera attached to the housing and configured to generate a second lower image by photographing below the housing, a third camera attached to the housing and configured to generate a third lower image by photographing below the housing, and a fourth camera attached to the housing and configured to generate a fourth lower image by photographing below the housing,
each of three cameras in the first camera, the second camera, the third camera, and the fourth camera is attached to the housing and has an optical axis that passes through a predetermined position,
one camera excluding the three cameras in the first camera, the second camera, the third camera, and the fourth camera is attached to the housing and has an optical axis that does not pass through the predetermined position,
the calculator calculates an angular velocity and the attitude of the mobile robot based on the first lower image, the second lower image, the third lower image, and the fourth lower image, and
the estimator estimates the self-position based on the angular velocity and the velocity.
